(19) United States
(12) Patent Application Publication
(10) Pub. No.: US 2026/0002875 A1
(43) Pub. Date: Jan. 1, 2026

(54) Semiconductor Workpiece Inspection System

(71) Applicant: Wolfspeed, Inc., Durham, NC (US)

(72) Inventors: Jared A. Langan, Apex, NC (US); Charles Henry Van Brackle, Holly Springs, NC (US); Edward Robert Van Brunt, Cary, NC (US)

(21) Appl. No.: 19/252,080

(22) Filed: Jun. 27, 2025

Related U.S. Application Data
(63) Continuation-in-part of application No. 18/759,356, filed on Jun. 28, 2024.

(51) Int. Cl. G01N 21/64; G01N 21/88; G01N 21/95

(52) U.S. Cl. CPC G01N 21/6489; G01N 21/645; G01N 21/8806; G01N 21/8851; G01N 21/9501; G01N 2021/6478; G01N 2021/8822; G01N 2201/06113

(57) ABSTRACT

Semiconductor workpiece inspection systems are provided. In some examples, a semiconductor workpiece inspection system includes a radiation source configured to provide electromagnetic radiation to a semiconductor workpiece. In some implementations, the example semiconductor workpiece inspection system includes an imaging device configured to capture an image of at least a portion of the semiconductor workpiece. In some implementations, the radiation source is configured to provide the electromagnetic radiation such that the electromagnetic radiation is incident on a surface of the semiconductor workpiece at an incident angle relative to an axis normal to a major surface of the semiconductor workpiece that is in a range of about 45° to about 85°.

### PRIORITY CLAIM

The present application is a continuation in part of and claims the benefit of priority of U.S. application Ser. No. 18/759,356, filed on Jun. 28, 2024, which is incorporated herein by reference for all purposes.

### FIELD

The present disclosure relates generally to manufacturing semiconductor devices and more particularly to semiconductor inspection systems.

### BACKGROUND

Semiconductor devices can be fabricated from workpieces of semiconductor material, such as silicon, sapphire, silicon carbide (SiC), and many others. These materials exhibit many attractive electrical and thermophysical properties, making them suitable for the fabrication of workpieces or substrates for high power density solid state devices, such as power electronic, radio frequency, and optoelectronic devices. During manufacturing, these materials may have crystalline material features at multiple length scales, from workpiece-sized features down to micron-scale features or sub-micron scale features (e.g., nanometer scale features). It may be desirable to detect and characterize these features during device manufacturing.

### SUMMARY

Aspects and advantages of embodiments of the present disclosure will be set forth in part in the following description, or can be learned from the description, or can be learned through practice of the embodiments.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion of the semiconductor workpiece. In some implementations, the radiation source is configured to provide the electromagnetic radiation such that the electromagnetic radiation is incident on a surface of the semiconductor workpiece at an incident angle relative to an axis normal to a major surface of the semiconductor workpiece that is in a range of about 45° to about 85°.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion of the semiconductor workpiece. In some implementations, the radiation source is configured to provide the electromagnetic radiation such that a projection of the electromagnetic radiation on a surface of the semiconductor workpiece is generally uniform.

In an aspect, the present disclosure provides an example semiconductor workpiece inspection system. In some implementations, the example semiconductor workpiece inspection system includes an ultraviolet laser source configured to direct ultraviolet coherent radiation to a silicon carbide semiconductor workpiece. In some implementations, the example semiconductor workpiece inspection system includes an imaging device configured to capture data associated with a photoluminescent response of at least a portion of the silicon carbide semiconductor workpiece. In some implementations, the ultraviolet laser source is configured to direct the ultraviolet coherent radiation such that the ultraviolet coherent radiation is incident on a surface of the silicon semiconductor workpiece at an incident angle that is within about 10 degrees of a Brewster angle for the semiconductor workpiece.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion semiconductor workpiece. In some implementations, the radiation source is configured to provide the electromagnetic radiation via an optical path such that the electromagnetic radiation has a first shape in the optical path and a second shape at a projection of the electromagnetic radiation on surface of the semiconductor workpiece. In some implementations, the second shape has increased uniformity relative to the first shape.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion of the semiconductor workpiece. In some implementations, the radiation source is configured to provide the electromagnetic radiation such that the electromagnetic radiation is incident on a surface of the semiconductor workpiece at an incident angle to increase a photoluminescent response from the semiconductor workpiece to the electromagnetic radiation from the radiation source relative to an incident angle parallel to an axis normal to the surface of the workpiece.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion of the semiconductor workpiece. In some implementations, the radiation source is configured to provide the electromagnetic radiation such that the electromagnetic radiation is incident on a surface of the semiconductor workpiece at a non-parallel incident angle relative to an axis normal to the surface of the semiconductor workpiece. In some implementations, the semiconductor workpiece imaging system is configured to provide a projection of the electromagnetic radiation on the surface of the semiconductor workpiece to increase uniformity of the projection to compensate for the non-parallel incident angle.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example semiconductor workpiece inspection system that includes a first imaging device and a second imaging device, according to certain embodiments.

FIG. 2 depicts another example semiconductor workpiece inspection system that includes a birefringent contrast imaging device and a photoluminescence imaging device, according to certain embodiments.

FIG. 3 depicts another example semiconductor workpiece inspection system that includes a birefringent contrast imaging device and a photoluminescence imaging device, according to certain embodiments.

FIG. 4 depicts a top perspective view of an example workpiece holder according to example embodiments of the present disclosure.

FIG. 5 depicts a close-up plan view of the example workpiece holder of FIG. 4 according to example embodiments of the present disclosure.

FIG. 6 depicts an example method that can be performed by one or more systems and/or controllers of said systems, according to certain embodiments.

FIG. 7 depicts a flow chart diagram of an example method according to example embodiments of the present disclosure.

FIG. 8 depicts an example semiconductor workpiece inspection system according to example embodiments of the present disclosure.

FIGS. 9A, 9B, 9C, and 9D depicts a shape of electromagnetic radiation at various stages of optical devices of a semiconductor workpiece inspection system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Power semiconductor devices are often fabricated from wide bandgap semiconductor materials, such as silicon carbide or Group III-nitride based semiconductor materials (e.g., gallium nitride). Herein, a wide bandgap semiconductor material refers to a semiconductor material having a bandgap greater than 1.40 eV. Aspects of the present disclosure are discussed with reference to silicon carbide (SiC)-based semiconductor structures as wide bandgap semiconductor structures. Those of ordinary skill in the art, using the disclosures provided herein, will understand that example embodiments of the present disclosure may be used with any semiconductor material, such as other wide bandgap semiconductor materials, without deviating from the scope of the present disclosure. Example wide bandgap semiconductor materials include silicon carbide and the Group III-nitrides.

Power semiconductor devices may be fabricated using epitaxial layers formed on a semiconductor workpiece, such as a silicon carbide semiconductor wafer. Example semiconductor workpieces may include or be formed of one or more crystalline semiconductor materials, such as silicon, silicon carbide, sapphire, or other suitable materials. The semiconductor workpiece may be subjected to various fabrication processes to form semiconductor devices on the semiconductor workpiece. Examples fabrication process may include, for instance, surface processing operations (e.g., grinding, lapping, polishing), epitaxial growth processes, deposition, etching, annealing, implantation, surface treatment, and/or other processes to form semiconductor devices on the semiconductor workpiece. Example fabrication processes includes both workpiece fabrication processes (e.g., fabricating semiconductor workpieces, such as silicon carbide semiconductor wafers) as well as various stages of semiconductor device fabrication using semiconductor workpieces (e.g., MOSFETs, Schottky diodes, HEMTs, IGBTs, etc.).

Crystalline materials (e.g., silicon carbide (SiC) crystalline materials, etc.) may be produced in crystal growth systems using various seeded sublimation crystal growth processes. More particularly, in some crystal growth processes, a seed material and source material are arranged in a reaction crucible which is then heated to the sublimation temperature of the source material. By controlled heating of the environment surrounding the reaction crucible, a thermal gradient is developed between the sublimating source material and the marginally cooler seed material. Based on the resulting thermal gradient, source material in a vapor phase is transported onto the seed material where it condenses to grow a bulk crystalline boule. This type of crystal growth process is commonly referred to as a physical vapor transport (PVT) process. In some examples, the resulting crystalline boule may then be diced (e.g., cut) into semiconductor wafers (e.g., semiconductor workpieces), which may then be used as seed material for a seeded sublimation growth process and/or as substrates upon which a variety of semiconductor devices (e.g., power semiconductor devices, discrete semiconductor packages, power modules, etc.) may be formed.

Those having ordinary skill in the art, using the disclosures provided herein, will appreciate that semiconductor workpieces of the present disclosure may be fabricated using any suitable fabrication process without deviating from the scope of the present disclosure.

Methods for forming semiconductor wafers from boules may include, for instance, cutting thin layers (e.g., wafers) from the boule using wire saws. Another example removal process for forming semiconductor wafers from boules may include a laser-based removal process. Laser-based removal processes may include providing subsurface laser damage patterns to a boule to form weakened areas in the boule. Portions may then be separated from the boule along the weakened areas to produce semiconductor wafers. Separation processes may include, for example, ultrasonic fracturing, mechanical force fracturing, or other fracturing methods.

The separating (e.g., fracturing) process may produce a rough and uneven surface on both the boule and the crystalline material substrates separated from the boule. For instance, in a laser-based removal process, laser strength, depth, weakened area proximity to other weakened areas, and laser power may contribute to the formation of residual cracks and defects protruding outward from the weakened areas which, in turn, create the rough surface of the boule and the semiconductor wafers removed from the boules.

Semiconductor devices and device manufacturing may require smooth surfaces on a semiconductor workpiece. Accordingly, in some cases, before continuing with further separations of the boule or further manufacturing with the semiconductor workpiece, rough surface(s) may need to be subjected to surface processing operations. For instance, in some examples, the surface of the boule may be smoothed to allow for the formation of subsequent laser damage regions in the boule. Otherwise, a rough surface on the boule may lead to undesirable reflection/refraction of one or more laser(s) used during formation of the subsurface laser damage regions for removal of subsequent semiconductor wafers. Methods for surface processing of boules and substates (e.g., semiconductor wafers) in semiconductor manufacturing may include grinding, lapping, and/or polishing the rough surfaces until sufficient smoothness is achieved.

Grinding is a material removal process that is used to remove material from the semiconductor workpiece. Grinding may be used to reduce a thickness of the semiconductor workpiece. Grinding typically involves exposing the semiconductor workpiece to an abrasive-containing surface, such as grind teeth on a grind wheel. Grinding may remove material of the semiconductor workpiece through engagement with the abrasive surface.

Lapping is a precision finishing process that uses a loose abrasive in slurry form. The slurry typically includes coarser particles (e.g., largest dimension of the particles being greater than about 100 microns) to remove material from the semiconductor workpiece. Lapping typically does not include engaging the semiconductor workpiece with an abrasive-containing surface on the lapping tool (e.g., a wheel or disc having an abrasive-containing surface). Rather, the semiconductor workpiece typically comes into contact with a lapping plate or a tile that is usually made of metal. Lapping typically provides better planarization of the semiconductor workpiece relative to grinding.

Polishing is a process to remove imperfections from the semiconductor workpiece to create a very smooth surface with low surface roughness. Polishing may be performed using a slurry and a polishing pad. The slurry typically includes finer particles relative to lapping, but coarser particles relative to chemical mechanical planarization (CMP). Polishing typically provides better planarization of the semiconductor workpiece relative to grinding.

Chemical mechanical planarization (CMP) is a type of fine or ultrafine polishing, typically used to produce a smoother surface ready, for instance, for epitaxial growth of layers on the semiconductor workpiece. CMP may be performed chemically and/or mechanically to remove imperfections and to create a very smooth and flat surface with low surface roughness. CMP typically involves changing the material of the semiconductor workpiece through a chemical process (e.g., oxidation) and removing the new material from the semiconductor workpiece through abrasive contact with a slurry and/or other abrasive surface or polishing pad (e.g., oxide removal). In CMP, the abrasive elements in the slurry typically remove the product of the chemical process and do not remove the bulk material of the semiconductor workpiece, often leaving very low subsurface damage.

Electrochemical Mechanical Polishing (ECMP) is a specialized process used in semiconductor manufacturing for polishing and planarizing surfaces with high precision. ECMP combines the principles of electrochemical and mechanical actions to achieve highly uniform material removal rates across the surface of a semiconductor workpiece. For example, a silicon carbide semiconductor workpiece may be mounted or provided on a workpiece carrier, which brings the wafer into contact with a polishing pad. A slurry (including an electrolyte solution) may be applied between the semiconductor workpiece and the polishing pad to facilitate the electrochemical reactions, carry away removed material, and provide lubrication for the mechanical polishing action. A bias (e.g., bias voltage and/or bias current) may be applied between the semiconductor workpiece and the electrolyte solution of the slurry to drive electrochemical reactions to occur at the surface of the semiconductor workpiece, leading to material dissolution. The electrochemical reactions may vary depending on the specific materials involved, but they often involve oxidation or reduction processes.

Crystalline SiC can include various structural crystal defects or extended defects, including dislocations (e.g., threading, edge, threading edge, basal plane, threading screw, screw, and/or super screw dislocations or micropipes, among others), hexagonal voids, and stacking faults, among others. Structural crystal defects may be formed during crystal growth and/or during heat-up or cooldown after growth where one or more discontinuities are formed in the material lattice structure of crystalline SiC. Such structural crystal defects can be detrimental to fabrication, proper operation, device yield, and reliability of semiconductor devices subsequently formed on SiC wafers.

In some cases, counting extended defects in SiC workpieces is accomplished by delineating etch pits and counting them manually, or with automated microscopy tools. Etching SiC reveals features such as etch pits that can be recognized and correlated to other characterization methods such as synchrotron x-ray topography (SXRT). Wafer etching effectively destroys usable wafer area, is expensive, requires corrosive chemistries, requires constant attention to maintain a viable process, and is time consuming. As such, certain technology for characterizing crystal defects involves destructively imaging the wafer being characterized, thereby rendering the characterized wafer useless for subsequent device fabrication. In this regard, only a few sacrificial wafers per crystal are typically sampled, which limits the amount of information available for process improvement and control. Accordingly, certain embodiments of nondestructive characterization of crystalline substrates or wafers (or “workpieces”), including defect detection, identification, and counting can provide significant advantages.

Crystalline material features can be introduced during the manufacturing process of the semiconductor workpiece, such as silicon carbide semiconductor workpieces. These features can range in width scale from nearly workpiece-size features to micron or sub-micron features (e.g., nanometer scale). Example features may include crystalline material features, such as threading edge dislocations, basal plane dislocations, super screw dislocations, micropipes, mixed dislocations, hexagonal voids, stacking faults, scratches, other polytypes, contamination, and other features. In certain examples, the feature width is less than or equal to about 10 microns. In certain examples, the feature width is less than or equal to about 3 microns. In certain embodiments, the feature width is in a range of about 1 micron and 25 microns. In certain embodiments, the feature width is less than 1 micron, such as in a range of about 1 nanometer to about 900 nanometers. As used herein, a “feature width” refers to a smallest dimension in the positional coordinate plane an image of the workpiece. Because of the significant variety of potential features and the range of potential sizes or lengths of features, it can be challenging to characterize and inspect the features of semiconductor workpieces at scale.

As SiC wafers are subjected to nondestructive methods for defect characterization, wafers in their final state may be characterized and subsequently used for device fabrication, vastly reducing the expense of the characterization process. This not only helps to reduce the cost of SiC wafers by reclaiming the characterized SiC wafer, but also allows for increased sampling at a marginal increase in cost. Accordingly, feedback loops between growth process development and production are accelerated.

However, traditional microscope-like systems, such may utilize a single optical column and a dichroic mirror in the infinity corrected space in order to direct light to multiple tube lenses. This can mean that the objective lens must be designed to be apochromatic across a huge wavelength range, and the inspection system may need to be optimized for the imaging conditions of every channel. This can add system complexity and expense, which may also be limiting in terms of the imaging modalities that can be employed.

Microscope-like systems can provide some positive benefits, such as high lateral resolution and long exposure time for a given measurement speed. Additionally or alternatively, Rayleigh-scattering or Brewster angle inspired systems (e.g., high speed rotation systems) can utilize a single pixel detector, which can result in having multiple detectors aimed at the same spot to achieve multiple channels. Such configurations, however, can be limited in lateral resolution due to the size of the laser spot (which may be preferentially large in certain photoluminescence measurements). Additionally or alternatively, high-speed rotation systems can include certain benefits, such as having separate light paths for various channels and/or having a highest theoretically possible measurement speed due to the deceleration of any axis during measurements. This may mean that all motions are continuous.

Accordingly, it may be beneficial to provide an inspection system that incorporates some aspects of both microscope-like inspection systems with some aspects of high-speed rotation systems. Additionally or alternatively it may be beneficial to have separate light path optimizations. For example, it may be beneficial to provide a multi-mode and/or multi-channel inspection system, as disclosed herein. The multi-channel inspection system can include, for example, a birefringence microscopy channel and/or an ultraviolet laser-excited photoluminescence channel.

It may be useful to allow for independent control of different channels of a semiconductor workpiece inspection system. For example, a first channel, such as a first inspection system, may be controlled independent of a second channel, such as a second inspection system. Additionally or alternatively, the first channel may be configured to be focused, tuned, and/or scanned without modifying the second channel. This independence can allow for precise and accurate imaging and/or review of the semiconductor workpiece to better detect any feature (e.g., abnormalities, impurities, etc.) thereon and/or therein.

Example aspects of the present disclosure can provide a number of technical effects and benefits, such as those described above, including improvements to computing technology and/or semiconductor fabrication technology. For instance, the use of multi-channel inspection systems can improve a system's ability to detect imperfections or deformities in a surface of a workpiece. Additionally or alternatively, the systems and methods described herein can identify a wider range of deformities using a multi-modal inspection system. In addition, the resulting images may have an image size such that correlated portions that inform the presence of a feature, such as a higher-resolution feature, are close in a pixel space with one another, improving the contrast of features in a surface of the workpiece, thus improving the system's ability to identify, localize, and/or classify the presence of the feature from the one or more images. Additionally or alternatively, the multi-channel inspection systems can include benefits of both microscope-like inspection systems with high-speed rotation inspection systems, as noted above.

Example aspects of the present disclosure provide improved systems and methods for inspecting and characterization of semiconductor workpieces. In particular, systems and methods according to example aspects of the present disclosure can obtain an image of a semiconductor workpiece. As used herein, an “image” is any two-dimensional representation of data. Data that is spatially coordinated (e.g., to an x and y position of a workpiece) may be referred to as an image. Imaging refers to collecting image data and does not require generating a visual representation of the image. For instance, imaging may refer to collecting data associated with positioning coordinates. In some examples, the images may be, for instance, optical surface microscopy images, photoluminescence (PL) microscopy images, cross-polarized light imaging (e.g., birefringent microscopy imaging) images, x-ray topography images, scanning electron microscopy images, or other images. The terms birefringent contrast imaging and cross-polarized light imaging may be used interchangeably in the present disclosure.

The workpiece image(s) can be captured by a suitable imaging device, such as PL microscope, x-ray topographic imaging source, cross-polarized light imaging source, camera, scanning electron microscope, etc. In some examples, the inspection system may generate a composite image of the semiconductor workpiece by spatially correlating (e.g., aligning, stitching, aggregating) multiple images (e.g., multiple different types of images).

Certain workpiece imaging solutions may be able to detect features, such as individual micropipes, basal plane dislocation, scratches, etc., using high resolution (e.g., about 1 to about 10 microns per pixel) and multi-channel semiconductor workpiece imaging. As one example, the imaging device may provide workpiece images at a resolution of about 1 micron to about 10 microns per pixel, such as about 3 microns to about 10 microns, such as about 3 microns per pixel to about 7 microns per pixel, such as about 1.7 microns per pixel (e.g., for optical microscopy images) or 3 microns per pixel (e.g., for PL images) or about 7 microns per pixel (for x-ray topography images).

The workpiece image can span an entire surface of the semiconductor workpiece and/or a workpiece holder. In some examples, the workpiece image can span a portion of the semiconductor workpiece. In some examples, multiple smaller images depicting portions of the semiconductor workpiece can be stitched or joined together to form the workpiece image.

Additionally, imaging data and corresponding images may include one or more data signals or data channels. For example, a data signal may comprise a light emission characteristic from a crystalline defect analyzed through a light filter. Data signals may correspond to absorption signals and/or emission signals.

In certain embodiments, PL data and images may be obtained for unetched wafers that may comprise polished or unpolished surfaces. During PL microscopy, the unetched wafers may be scanned with both visible and ultraviolet (UV) light and surface images and near infrared (NIR) filtered light channels are recorded. Besides NIR filtered light, any PL emission measurements may be recorded depending on the embodiment. During PL microscopy, any light source may be selected that has a suitable wavelength spectrum configured to provide PL emission of a specific material. For example, a suitable wavelength spectrum for SiC may include UV light. Any defects in the wafer are illuminated to the penetration depth of the UV light and also on the surface if present. The output of the PL images includes optically reflecting defects and UV-excited emission from defects across the wafer surface. Mapping the UV-excited PL emission in a SiC wafer may be useful to understand the distribution of defects in the SiC wafer that would underlie potential devices fabricated thereon.

In certain embodiments, certain images may correspond to respective portions of a SiC wafer, and a plurality of such images may collectively correspond to an entire surface of a particular wafer. Furthermore, “images” may be categorized and/or distinguished based on a corresponding “image modality” which, as used herein, refers to a method, technique, and/or principle used to obtain the “image.” By way of non-limiting example, a “birefringent contrast image” refers to an image captured in a birefringent contrast image modality. Likewise, a “photoluminescence image” refers to an image captured in a photoluminescence image modality.

For instance, birefringent contrast image modalities may generally be based on detecting light transmitted through a semiconductor workpiece. Photoluminescence image modalities may generally be based on detecting light emitted from a semiconductor workpiece. Aspects of the present disclosure are similarly directed to and applicable to image modalities based on detecting reflected light from the semiconductor workpiece (e.g., reflectance imaging).

Example aspects of the present disclosure may relate to a fiducial structure. The fiducial structure of the present disclosure may be used to spatially correlate (e.g., align) a plurality of images of the semiconductor workpiece. The fiducial structure may include at least one fiducial marker that is detectable in a plurality of different image modalities. Example fiducial markers may have any suitable pattern, such as an ArUco pattern, an AprilTag pattern, a CALTag pattern, an ARTag pattern, and/or the like.

The example fiducial markers may include an internal first region of a material of first optical characteristics and a second region at least partially around the internal first region. The second region may be a material having second optical characteristics that are different from the first optical characteristics. In some examples, the first region may transmit light in a transmission-based light imaging modality (e.g., birefringent contrast imaging modality). The second region may not transmit light in the transmission-based light imaging modality (e.g., birefringent contrast imaging modality). The first region may emit light in an emission-based light imaging modality (e.g., photoluminescence imaging modality). The second region may not emit light in an emission-based light imaging modality (e.g., photoluminescence imaging modality). The first region may not reflect light in a reflection-based imaging modality. The second region may reflect light in the reflection-based imaging modality. In some examples, the first region is a non-blocking region, and the second region is a blocking region comprising a metal region or a ceramic region (e.g., ZnO, ZnS).

In some examples, the fiducial structures include a semiconductor structure. The semiconductor structure may be the same material and/or have the same optical properties as the semiconductor workpiece. In some examples, the optical axis of the semiconductor structure of the fiducial structure may match or align with the optical axis of the semiconductor workpiece. For instance, in the case of silicon carbide having a hexagonal crystal structure, the c-axis of the hexagonal crystal structure may be aligned with a c-axis of the hexagonal crystal structure of the semiconductor structure. For instance, if the semiconductor workpiece is on-axis 4H or 6H silicon carbide, the semiconductor structure of the fiducial structure may be on axis 4H or 6H silicon carbide. If the semiconductor workpiece is off-axis 4H or 6H silicon carbide, the semiconductor structure of the fiducial structure may be off-axis 4H or 6H silicon carbide. The c-axis of the off-axis silicon carbide of the semiconductor workpiece may be aligned or match with the c-axis of the off-axis of the off-axis semiconductor structure of the fiducial structure. For instance, if the semiconductor workpiece is a 4° off-axis silicon carbide semiconductor workpiece, the semiconductor structure may be 4° off-axis silicon carbide.

It will be understood that when an element such as a layer, structure, region, or substrate is referred to as being “on” or extending “onto” another element, it may be directly on or extend directly onto the other element or intervening elements may also be present and may be only partially on the other element. In contrast, when an element is referred to as being “directly on” or extending “directly onto” another element, there are no intervening elements present, and may be partially directly on the other element. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

As used herein, a first structure “at least partially overlaps” or is “overlapping” a second structure if an axis that is perpendicular to a major surface of the first structure passes through both the first structure and the second structure. A “peripheral portion” of a structure includes regions of a structure that are closer to a perimeter of a surface of the structure relative to a geometric center of the surface of the structure. A “center portion” of the structure includes regions of the structure that are closer to a geometric center of the surface of the structure relative to a perimeter of the surface. “Generally perpendicular” means within 15 degrees of perpendicular. “Generally parallel” means within 15 degrees of parallel. In some embodiments, a “major surface” of a semiconductor workpiece refers to one of the two opposing, substantially planar surfaces having a significantly larger area than any other surface.

Relative terms such as “below” or “above” or “upper” or “lower” or “horizontal” or “lateral” or “vertical” may be used herein to describe a relationship of one element, layer or region to another element, layer or region as illustrated in the figures. It will be understood that these terms are intended to encompass different orientations of the device in addition to the orientation depicted in the figures.

Embodiments of the disclosure are described herein with reference to cross-section illustrations that are schematic illustrations of idealized embodiments (and intermediate structures) of the invention. The thickness of layers and regions in the drawings may be exaggerated for clarity. Additionally, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Similarly, it will be understood that variations in the dimensions are to be expected based on standard deviations in manufacturing procedures. As used herein, “approximately” or “about” includes values within 10% of the nominal value.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

In the drawings and specification, there have been disclosed typical embodiments and, although specific terms are employed, they are used in a generic and descriptive sense only and not for purposes of limitation of the scope set forth in the following claims.

Aspects of the present disclosure are discussed with reference to input data that includes images of semiconductor workpieces. Those of ordinary skill in the art, using the disclosures provided herein, will understand that aspects of the present disclosure may be applicable to other types of data, such as other types of images, without deviating from the scope of the present disclosure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to figures that are provided as schematic illustrations of various embodiments of the disclosure. As such, the actual thickness of the layers or elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to exclusively illustrate the precise shape of a region of a device and are not intended to limit the scope of the disclosure. Common elements between figures may be shown herein with common element numbers and may not be subsequently redescribed.

As used herein, the term “light” is not restricted to visible light. The term “light” can refer to any electromagnetic radiation, such as electromagnetic radiation that is responsive to optical elements, such as reflectors, refractors, and/or diffractors, such as infrared radiation, ultraviolet radiation, visible light (e.g., a wavelength of about 380 nm to about 700 nm), or other electromagnetic radiation. The term “radiation” may be used synonymously with “light” herein.

A “channel” may refer to a system of components operable to obtain images of a certain image modality. A “channel” may include the radiation source, the detector, and the optical path between the radiation source and the detector. The channel can include one or more optical elements (e.g., reflectors, refractors, splitters, diffractors, attenuators, amplifiers, sensors, etc.) in the optical path between the radiation source and the target.

As used herein, the use of the term “optical” in conjunction with an element, path, or other term does not restrict the element, path, or other term to visible light, but may be associated with any electromagnetic radiation, such as visible light, infrared radiation, ultraviolet radiation, etc.

As used herein, a “substrate” and a “wafer” both refer to a crystalline material, such as a single crystal semiconductor material. In certain embodiments, a substrate may have sufficient thickness (i) to be surface processed (e.g., lapped and/or polished) to support epitaxial deposition of one or more semiconductor material layers, and optionally (ii) to be free-standing. In certain embodiments, a substrate may have a generally cylindrical or circular shape, and/or may have a thickness of at least about one or more of the following thicknesses: 200 microns (um), 300 um, 350 um, 750 um, 1 millimeter (mm), 2 mm, 3 mm, 5 mm, 1 centimeter (cm), 2 cm, 5 cm, 10 cm, 20 cm, 30 cm, or more.

In certain embodiments, a substrate may comprise a diameter of approximately 100 mm or greater, approximately 150 mm or greater, or approximately 200 mm or greater, or approximately 300 mm or greater, or approximately 450 mm or greater, or in a range including approximately 100 mm to approximately 450 mm, or in a range including approximately 150 mm to approximately 450 mm, or in a range including approximately 150 mm to approximately 300 mm, or in a range including approximately 200 mm to approximately 300 mm.

With regard to relative dimensions, the term “approximately” is defined to mean a nominal dimension within a certain tolerance, such as +/−5 mm from a diameter dimension. For example, as used herein, a wafer with a “200 mm” diameter may encompass a diameter range including 195 mm to 205 mm, a wafer with a “300 mm” diameter may encompass a diameter range including 295 mm to 305 mm, and a wafer with a “450 mm” diameter may encompass a diameter range including 445 mm to 455 mm. In further embodiments, such tolerances may be smaller, such as plus or minus 1 mm, or plus or minus 0.25 mm. In certain embodiments, a substrate may comprise 4H-SiC with a diameter of approximately 100 mm, 150 mm, 200 mm, or greater, and a thickness in a range of 100 to 1000 um, or in a range of 100 to 800 um, or in a range of 100 to 600 um, or in a range of 150 to 500 um, or in a range of 150 to 400 um, or in a range of 200 to 500 um, or in any other thickness range or having any other thickness value specified herein. In certain embodiments, the terms “substrate” and “wafer” may be used interchangeably as a wafer is typically used as a substrate for semiconductor devices that may be formed thereon. As such, a substrate or a wafer may refer to free-standing crystalline material that has been separated from a larger or bulk crystalline material or substrate.

Aspects of the present disclosure are discussed with reference to a semiconductor workpiece that is a semiconductor wafer that includes silicon carbide (“silicon carbide semiconductor wafer”) for purposes of illustration and discussion. Those of ordinary skill in the art, using the disclosures provided herein, will understand that aspects of the present disclosure can be used with other semiconductor workpieces. Other semiconductor workpieces may include carrier substrates, ingots, boules, polycrystalline substrates, monocrystalline substrates, bulk crystalline material having a thickness of greater than about 1 mm, such as greater than about 5 mm, such as greater than about 10 mm, such as greater than about 20 mm, such as greater than about 50 mm, such as greater than about 100 mm, to 200 mm, etc.

In some examples, the semiconductor workpiece includes silicon carbide crystalline material. The silicon carbide crystalline material may have a 4H crystal structure, 6H crystal structure, or other crystal structure. The semiconductor workpiece can be an on-axis workpiece (e.g., end face parallel to the (0001) plane) or an off-axis workpiece (e.g., end face non-parallel to the (0001) plane), such as a 2°, 4°, 6°, or 8° off-axis workpiece.

Methods disclosed herein may be applied to substrates or wafers of various crystalline materials, of both single crystal and polycrystalline varieties. In certain embodiments, methods disclosed herein may utilize cubic, hexagonal, and other crystal structures, and may be directed to crystalline materials having on-axis and off-axis crystallographic orientations. In certain embodiments, methods disclosed herein may be applied to semiconductor materials and/or wide bandgap materials. Exemplary materials include, but are not limited to, SiC, silicon (Si), gallium arsenide (GaAs), sapphire, and diamond. In certain embodiments, such methods may utilize single crystal semiconductor materials having hexagonal crystal structure, such as 4H-SiC, 6H-Sic, or Group III nitride materials (e.g., gallium nitride (GaN), aluminum nitride (AlN), indium nitride (InN), indium gallium nitride (InGaN), aluminum gallium nitride (AlGaN), or aluminum indium gallium nitride (AlInGaN)).

With reference now to the Figures, example embodiments of the present disclosure will be discussed in further detail.

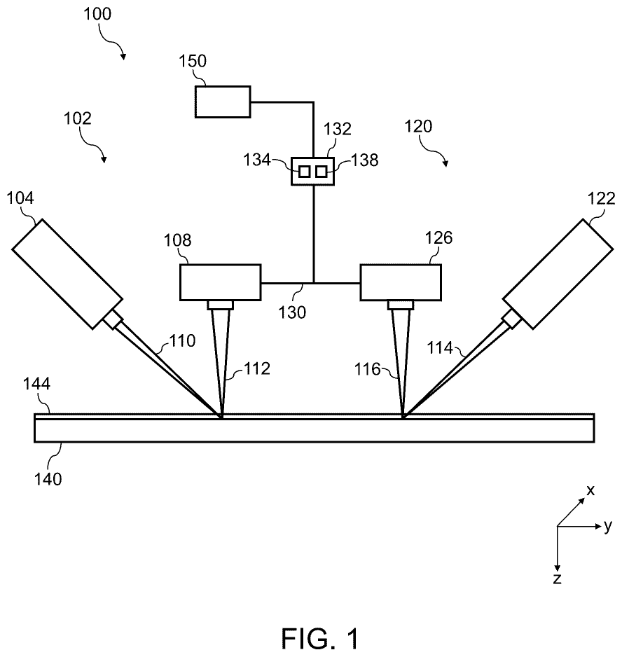

FIG. 1 depicts an example semiconductor workpiece inspection system 100 that includes a first imaging device 102 and a second imaging device 120, according to certain embodiments. Additionally or alternatively, the semiconductor workpiece inspection system 100 can include a controller 132. In some embodiments, the semiconductor workpiece inspection system 100 includes a sensor 150.

The first imaging device 102 can include a first radiation source 104 and a first detector 108. The second imaging device 120 can include a second radiation source 122 and a second detector 126. The first radiation source 104 and/or the second radiation source 122 can be configured to direct light at a semiconductor workpiece 140. The semiconductor workpiece 140 can have a front face and a back face opposite the front face. The front face may be proximal to the first detector 108 and/or the second detector 126. The first radiation source 104 can direct first incident light 110 onto a first portion of the semiconductor workpiece 140. Additionally or alternatively the second radiation source 122 can direct second incident light 114 onto a second portion of the semiconductor workpiece 140. The first and second portions of the semiconductor workpiece 140 may be the same portion or they may be different. The semiconductor workpiece 140 may direct light at the first portion of the semiconductor workpiece 140 before, concurrent with, or after the second radiation source 122 directs the second incident light 114 at the second portion of the semiconductor workpiece 140.

The first incident light 110 can be reflected and/or transmitted by the semiconductor workpiece 140, resulting in first detectable light 112 that is detected by the first detector 108. The second incident light 114 can be reflected and/or transmitted by the semiconductor workpiece 140, resulting in second detectable light 116 that is detected by the second detector 126. First detectable light 112 and second detectable light 114 is illustrated as reflected light for purposes of illustration and discussion. Those of ordinary skill in the art, using the disclosures provided herein, will understand that the first detectable light 112 and/or second detectable light may be transmitted light. Additionally or alternatively, the first detectable light 112 and/or the second detectable light 116 may be emitted by the semiconductor workpiece 140 as photoluminescence (e.g., fluorescence). For example, the first incident light 110 and/or the second incident light 114 may excite respective portions of the semiconductor workpiece 140 and result in a delayed light emission by the semiconductor workpiece 140.

In some embodiments, the first incident light 110 and/or the second incident light 114 are transmitted through the semiconductor workpiece 140. For example, the first incident light 110 and/or the second incident light 114 may include a wavelength of light or other aspect of light that allows the light to substantially pass through the semiconductor workpiece 140. For example, in some embodiments, the first incident light 110 and/or the second incident light 114 comprises infrared light (e.g., near-infrared (NIR) light), green light (e.g., wavelength of about 515 nm to about 570 nm), red light (e.g., wavelength of about 630 nm to about 700 nm).

The first radiation source 104 and/or the second radiation source 122 can be configured to emit light that is polarized (e.g., elliptically, linearly) or unpolarized, pulsed or continuous, coherent or incoherent, visible or invisible, and/or light of one or more wavelengths or wavelength ranges.

The first imaging device 102 and/or the second imaging device 120 can obtain workpiece images from the surface of the semiconductor workpiece 140. The workpiece images may have a resolution described herein, which may be dependent in part on a resolution of the first imaging device 102 and/or the second imaging device 120. As one example, the resolution may have approximately 1 micron per pixel to about 10 microns per pixel. However, in some examples, the resolution may be less than 1 micron per pixel. The imaging device 102, 120 may include any suitable imaging device, such as a PL microscope, x-ray topographic imaging source, cross-polarized light imaging (e.g., birefringent contrast imaging) source, camera, infrared camera, camera associated with non-visible light wavelengths, scanning electron microscope, or other suitable device configured to obtain data associated with spatial coordinates of the workpiece.

In some embodiments, the semiconductor workpiece inspection system 100 may include one or more detectors, such as the first detector 108 and/or the second detector 126, for obtaining image data associated with the semiconductor workpiece 140, such as workpiece characterization data for the semiconductor workpiece 140. Workpiece characterization data is data that provides information associated with the semiconductor workpiece 140, such as topography, surface roughness, parallelism, optical wedge(s), presence of anomalies, doping, thickness, and/or other characteristics. Workpiece characterization data may include, for instance, an image of the surface of the semiconductor workpiece 140 and/or a topological map of the surface of the semiconductor workpiece 140. In some embodiments, the one or more detectors 108, 126 may include depth sensors such as one or more surface measurement lasers or other illuminators (e.g., CCS) or sensors (e.g., ultrasonic sensors) that may be operable to emit a laser or other light onto the surface of the semiconductor workpiece 140 and scan the surface (e.g., based on reflections of the light) for depth measurements, topography measurements, etc. of the surface of the semiconductor workpiece 140. Other suitable sensors may be used without deviating from the scope of the present disclosure.

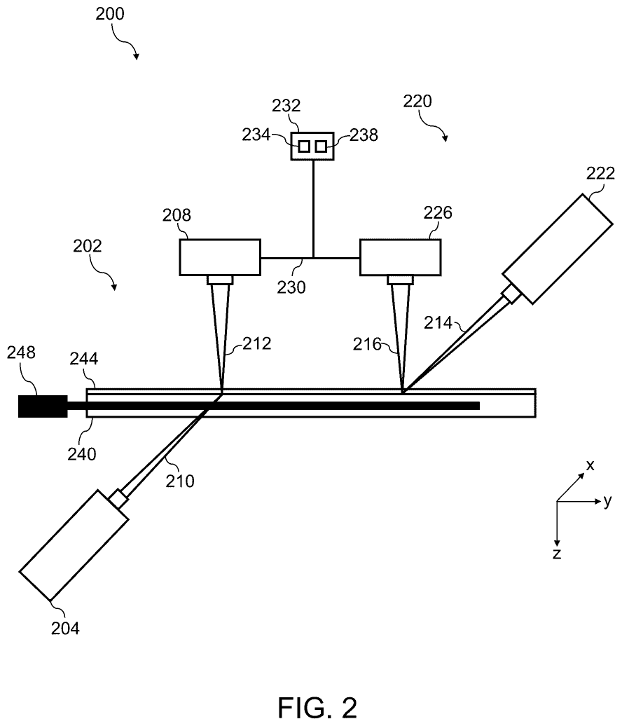

In some embodiments, the semiconductor workpiece inspection system 100 includes a fiducial structure 144. The fiducial structure 144 can be on the semiconductor workpiece 140 and/or on a workpiece holder (not shown in FIG. 1, but see workpiece holder 248 of FIG. 2). The fiducial structure 144 can be configured to be visible by one or more of the first imaging device 102 and/or the second imaging device 120. The fiducial structure 144 can be etched into, layered on (e.g., using evaporation), attached to, or otherwise formed as part of the semiconductor workpiece 140 and/or the workpiece holder. The fiducial structure 144 can include one or more fiducial markers individually identifiable by the first imaging device 102 and/or the second imaging device 120.

In some embodiments, the semiconductor workpiece inspection system 100 includes a sensor 150. The sensor 150 can be configured to identify, characterize, or otherwise analyze characterization data about the semiconductor workpiece 140, such as topography, roughness, presence of anomalies, doping, thickness, and/or other characteristics. The sensor 150 can include an imaging sensor, a feature sensor, a RADAR or LIDAR sensor, a thermal sensor, or some other sensor that can be used to obtain feature or other data described herein for characterizing the semiconductor workpiece 140.

The semiconductor workpiece inspection system 100 can additionally or alternatively include a controller 132 that includes a memory 134 and a processor 138. The memory 134 can include one or more memory devices, and/or the processor 138 can include one or more processors. The processor 138 can include an electronic and/or hardware processor. The memory 134 can include non-transitory memory. The memory 134 may store computer-readable instructions that when executed by the processor 138 cause the memory 134 to perform one or more control functions, such as any of the functions described herein.

The controller 132 may be in communication with various other aspects of the semiconductor workpiece inspection system 100 through one or more wired and/or wireless control links, such as the communication interface 130. The communication interface 130 can be a wired and/or wireless data communication link informationally connecting the first imaging device 102 (e.g. via the first detector 108), the second imaging device 120 (e.g., via the second detector 126), and/or the controller 132. The controller 132 may send control signals to the various components of the semiconductor workpiece inspection system 100 (e.g., the workpiece holder, the imaging device 102, 120, etc.) to implement the aspects of the present disclosure described herein. Additionally, the controller 132 may include one or more imaging models (e.g., machine-learned models) for inspecting and/or characterizing the semiconductor workpiece 140, as described herein. For instance, by way of non-limiting example, the controller 132 (e.g., via the processor 138) may be configured to determine one or more workpiece characteristics (e.g., defects, surface roughness, parallelism, optical wedge(s), anomalies, doping, thickness, etc.) of the semiconductor workpiece 140 based at least in part on composite image data associated with the semiconductor workpiece 140. Additionally and/or alternatively, in some examples, the controller 132 (e.g., via the processor 138) may be configured to generate feedback data indicative of one or more defects associated with a fabrication process (e.g., a crystal growth process, a grinding process, a lapping process, a polishing process, etc.) of the semiconductor workpiece 140.

FIG. 2 depicts another example semiconductor workpiece inspection system 200 that includes a birefringent contrast imaging device 202 and a photoluminescence imaging device 220, according to certain embodiments. The semiconductor workpiece inspection system 200 can include the birefringent contrast imaging device 202, the photoluminescence imaging device 220, the semiconductor workpiece 240, the workpiece holder 248, and/or the controller 232.

The birefringent contrast imaging device 202 can include an infrared radiation source 204 and an optical detector 208. In some embodiments, the birefringent contrast imaging device 202 includes certain beam-modifying optical elements configured to control a beam shape, size, direction, and/or other aspect of the beam characteristics.

The radiation source 204 can be configured to generate and direct incident polarized light 210 at the semiconductor workpiece 240. In some examples, the radiation source 204 can include a coherent radiation source, such as a laser. The radiation source 204 may output infrared light, such as near-infrared (NIR) light. In some examples, the radiation source 204 may output green light (e.g., 515 nm to about 570 nm), red light (e.g., about 660 nm to about 700 nm) or light of other suitable wavelength range. The incident polarized light 210 can be linearly or circularly polarized light. In some embodiments, the radiation source 204 can be configured to output despeckled light. For example, the birefringent contrast imaging device 202 can include a spatial filter, such as a pinhole or a diffuser. The spatial filter can remove high spatial frequency components of the incident polarized light 210 resulting in a despeckled output. Additionally or alternatively, the birefringent contrast imaging device 202 can introduce controlled fluctuations in the phase or frequency of the incident polarized light 210 over time. This can provide temporal disruptions to the coherence of the incident polarized light 210. Other methods may be possible.

The incident polarized light 210 can be used to image and/or characterize one or more surfaces (e.g., front surface proximal to the optical detector 208 as shown, back surface proximal to the radiation source 204 as shown). The incident polarized light 210 may be at least partially transmitted through the semiconductor workpiece 240 as shown, resulting in transmitted light 212 that can be captured by the optical detector 208. The birefringent characteristics of the workpiece (e.g., silicon carbide) may alter or modify the polarization of the polarized light 210 as it is transmitted through the workpiece 240. This modification in polarity may be detected by the optical detector 208. The optical detector 208 can include at least one of a SPAD (single photon avalanche detector) single line detector, an electron-multiplying CCD (charge coupled device) detector, or a charge domain CMOS TDI (time delay and integration) sensor. The transmitted light 212 (e.g., as a result of the birefringent nature of the material) may contain information about the one or more surfaces or bulk of the semiconductor workpiece 240. Features (e.g., defects) described above may be visible as dark or light contrasts at the optical detector 208. For example, a polarization of the incident polarized light 210 may be modified by features found on the one or more surfaces (and/or in the depth or bulk) of the semiconductor workpiece 240. These features may be visible by detecting the transmitted light 212 indicative of the modified polarizations.

In some embodiments, one or more of the birefringent contrast imaging device 202 and/or the photoluminescence imaging device 220 is configured to generate a darkfield image. Additionally or alternatively, the semiconductor workpiece inspection system 200 can generate a brightfield image using reflected light (e.g., in the birefringent contrast imaging device 202 and/or the photoluminescence imaging device 220). Other imaging devices may be used.

The radiation source 204 can be configured (e.g., controlled by the controller 232) to focus the incident polarized light 210 at a target x-, y-, and z-position on or within the semiconductor workpiece 240. The radiation source 204 may scan the focused beam along a first axis (e.g., x-axis, y-axis, z-axis). Such a scan may be referred to as a “line scan”. In some embodiments, the first axis is the x-axis. In some embodiments, the first axis is the y-axis. Multiple such line scans may be made along the first axis. The multiple line scans along the first axis can have a width measured along a second axis (e.g., a second axis within the x-y plane). The width can have any value without deviating from the scope of the present disclosure. In some examples, the width may be in a range of about 1 microns to about 50 mm, such as in a range of about 1 mm to about 40 mm, such as in a range of about 4 mm to about 25 mm, such as about 1 micron, about 2 microns, about 3 microns, about 5 microns, about 8 microns, about 10 microns, about 15 microns, about 25 microns, about 35 microns, about 50 microns, about 75 microns, about 100 microns, about 200 microns, about 250 microns, about 500 microns, about 1 mm, about 2 mm, about 3 mm, about 5 mm, about 10 mm, having any value therebetween, or fall within a range having any of those widths as endpoints. In some embodiments, the line scans have a width of about 14 mm to about 25 mm. These line scans can be stitched together along the second axis to create a two-dimensional stitched mapping of the surface (or other depth along the z-axis) of the semiconductor workpiece 240. As described in more detail below, each line scan can be spatially correlated (e.g., aligned, combined) using one or more fiducial markers so that the stitched mapping can be accurately made. As used herein, “spatial correlation” refers to a relationship and/or similarity between one or more pixels in each of a plurality of images, the spatial coordinates of each of the plurality of images, and/or the like, and “spatially correlating” refers to aligning, combining, and/or otherwise correlating each of the plurality of images based at least in part on the relationship and/or similarity between the one or more pixels, the spatial coordinates, and/or the like.

In some embodiments, the controller 232 causes the radiation source 204 to perform this two-dimensional mapping of the semiconductor workpiece 240 at the target z-axis position, and to perform multiple such two-dimensional mappings of the semiconductor workpiece 240. In some embodiments, each of the two-dimensional mappings can have a depth (in the z-axis) of any width described above regarding the width of the line scans. For example, in some embodiments, the depth of the two-dimensional mappings is about 1 mm. These two-dimensional mappings can be further stitched together to create a three-dimensional mapping of the semiconductor workpiece 240. As with the line scans above, the two-dimensional mappings may be spatially correlated precisely based on fiducial markers of the fiducial structure 244 so that the multiple two-dimensional mappings can be properly stitched together for an accurate three-dimensional mapping of the semiconductor workpiece 240.

This three-dimensional mapping can be stored in the memory 234 of the controller 232. In some embodiments, the three-dimensional mapping can be spatially correlated (e.g., using the fiducial markers of the semiconductor workpiece 240) with a corresponding three-dimensional mapping created using a different modality (e.g., a photoluminescent three-dimensional mapping created using the photoluminescence imaging device 220). Additionally or alternatively, one or more two-dimensional mappings of a first modality (e.g., from the birefringent contrast imaging device 202) can be compared with corresponding two-dimensional mappings of a second modality (e.g., from the photoluminescence imaging device 220). In some embodiments, individual line scans of the first modality along the first axis can be spatially correlated and compared to (and/or merged with) corresponding line scans of the second modality.

The photoluminescence imaging device 220 can be configured (e.g., under control of the controller 232) to image one or more portions of the semiconductor workpiece 240. The ultraviolet radiation source 222 can direct incident ultraviolet light 214 onto a target surface or at a target depth of the semiconductor workpiece 240. The ultraviolet radiation source 222 can include at least one of a laser, an LED, or an arc lamp. The incident ultraviolet light 214 can be calibrated to be absorbed by the semiconductor workpiece 240, causing the semiconductor workpiece 240 to emit resultant photoluminescent light 216. The photoluminescent light 216 can include fluorescent light. The ultraviolet light 214, in some embodiments, can have a wavelength in a range of about 300 nm to about 400 nm, such as about 350 nm to about 400 nm, such as about 385 nm to about 400 nm, such as about 355 nm, such as about 308 nm, etc.

The photoluminescence detector 226 can be configured to obtain imagery of the target surface or depth of the semiconductor workpiece 240. The photoluminescent light 216 can provide feature (e.g., imperfection, defect) information at the target position of the semiconductor workpiece 240. As described above with regard to the birefringent contrast imaging device 202, the photoluminescence imaging device 220 can obtain one or more line scans of the semiconductor workpiece 240 along a first axis (e.g., x-axis, y-axis). These line scans may be stitched together along a second axis in the x-y plane such that a two-dimensional mapping can be created. The line scan(s) and/or two-dimensional mapping(s) can have one or more features common with those described above with regard to the birefringent contrast imaging device 202. The line scan(s), two-dimensional mapping(s), and/or three-dimensional mapping(s) can include the fiducial markings so that the controller 232 can properly spatially correlate the line scan(s) and/or corresponding mapping(s) with the appropriate line scans and/or mappings of another modality (e.g., from the birefringent contrast imaging device 202).

The semiconductor workpiece inspection system 200 can additionally or alternatively include a workpiece support or workpiece holder 248. The workpiece holder 248 can be configured to support the semiconductor workpiece 240. The workpiece support may include a chuck (e.g., a vacuum chuck) or other mechanism to secure the semiconductor workpiece 240 during processing by the semiconductor workpiece inspection system 200. Additionally or alternatively, in some implementations, the workpiece holder 248 may provide a surface on which the semiconductor workpiece 240 rests. In some implementations, the workpiece holder 248 may provide for moving, rotating, angling, or otherwise reorienting the semiconductor workpiece 240 relative to the rest of the semiconductor workpiece inspection system 200. In some examples, the workpiece holder 248 provides a support surface along a peripheral edge of the semiconductor workpiece 240 so that light or other radiation may be transmitted through the semiconductor workpiece 240 without obstruction by the workpiece holder 248. In some examples, the semiconductor workpiece inspection system 200 may include a workpiece handling robot operable to move the workpiece to the workpiece holder 248.

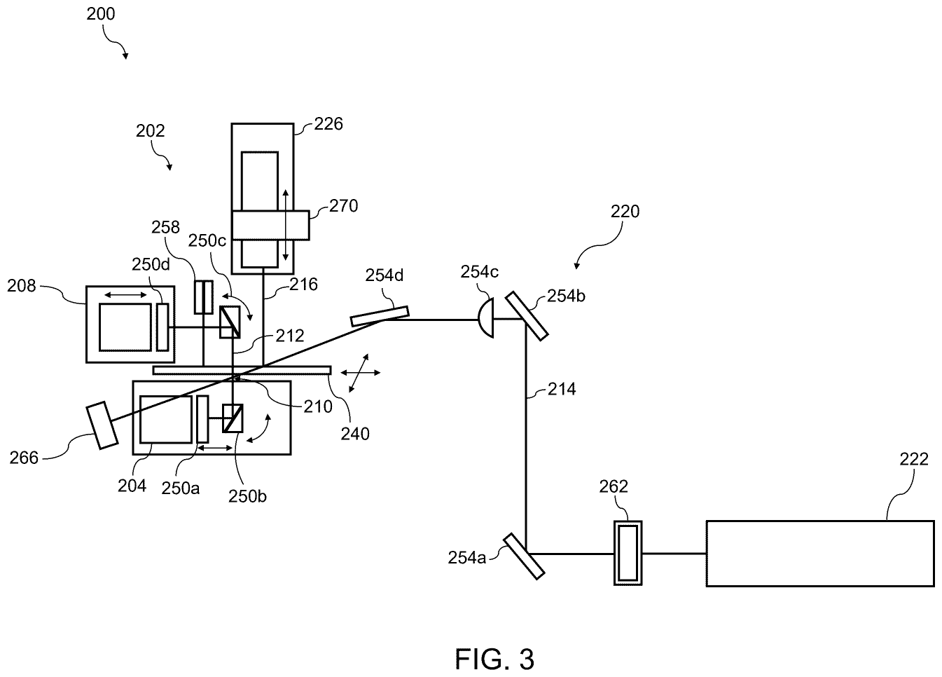

FIG. 3 depicts another example semiconductor workpiece inspection system 200 that includes a birefringent contrast imaging device 202 and a photoluminescence imaging device 220, according to certain embodiments. The birefringent contrast imaging device 202 includes an infrared radiation source 204, an optical detector 208, one or more first optical elements 250a-d, an illuminator 258, and/or a power meter 266. In some embodiments, the photoluminescence imaging device 220 additionally or alternatively includes a power meter 266. For example, as shown, the power meter 266 can be in the optical path of the incident ultraviolet light 214, as described in more detail below. It can detect an amount of light transmitted through the semiconductor workpiece 240.

As shown in FIG. 3, the radiation source 204 may be configured to be movable along an x-axis. In some embodiments, the radiation source 204 is moveable along two or three axes. This movement allows the controller (not shown) to focus the incident polarized light 210 onto the target location on or within the semiconductor workpiece 240, as well as to scan the semiconductor workpiece 240 along one or more target axes. Additionally or alternatively, the birefringent contrast imaging device 202 can include one or more first optical elements 250a-d that can aid in movement, beam characteristics, and/or focusing of the incident polarized light 210. For example, the optical element 250a can include a polarizing element, such as a polarizer. The polarizing element may include a waveplate (e.g., half waveplate, quarter waveplate) and/or a polarizing beamsplitter. In some embodiments, the optical element 250a can include an optical filter. Such an optical filter may, for example, be used to select for a particular wavelength of infrared (e.g., near infrared) light that will image the features on or within the semiconductor workpiece 240.

Additional optical elements, such as the optical element 250b and/or the optical element 250c may be included to control the beam of the incident polarized light 210. The optical element 250b and/or the optical element 250c may include reflective elements, such as mirrors and/or beamsplitters. As indicated in FIG. 3, one or more of the optical elements 250b, 250c may be configured to rotate along one or more axes. Additionally or alternatively, they may be able to translate along one or more axes. Such degrees of freedom can allow for a high level of precision in directing the beam path through and to focus the beam at the target location of the semiconductor workpiece 240. It may be advantageous to effectively rotate the incident polarized light 210 by a target amount (e.g., 90 degrees). For example, it may be helpful to change which portion of the incident polarized light 210 is the ordinary and which is the extraordinary relative to the particular orientation of the semiconductor workpiece 240. In some embodiments, it may be possible to simultaneously image the same location of the semiconductor workpiece 240 along both axes, perhaps using a polarizing beamsplitter to direct both ordinary and extraordinary beams at the same target location simultaneously.

In some embodiments, the optical elements 250b, 250c include compensators, such as retardation plates. The compensators can introduce a controlled phase delay between the orthogonal components of the incident polarized light 210. Additionally or alternatively, they can adjust the relative phase between the ordinary and extraordinary rays passing through the semiconductor workpiece 240. This can allow for the observation of interference patterns and enhancing contrast of any features in the semiconductor workpiece 240.

The optical element 250d may include another polarizer. For example, the optical element 250d may include an analyzer. The analyzer, for a workpiece with no changes in optical polarization, should completely block the incident light for a cross-polarization modality. The birefringence of the sample may change the polarization of the incident light, so that it is not totally blocked by the analyzer at the site of defects. The optical element 250d can be oriented at a specific angle relative to another polarizer (e.g., the optical element 250a).

In some embodiments, the birefringent contrast imaging device 202 can include an illuminator 258. The illuminator 258 can be configured to illuminate a surface of the semiconductor workpiece 240. The illuminator 258 may be configured to output light (e.g., visible light), but other wavelength ranges are also possible. The illuminator 258 may emit light suitable to facilitate capturing line scan images of the workpiece 240. The illuminator 258 may be a source of monochromatic light that has close to a single polarization. In some examples, the illuminator 258 is a laser. In some examples, the illuminator 258 is an LED with some wavelength spread. The illuminator 258 may provide linearly or circularly polarized light.

In some embodiments, the illuminator 258 may include or be a part of a confocal chromatic sensor. The confocal chromatic sensor can focus a radiation source of at least one of the first or second imaging devices. The confocal chromatic sensor can be configured to be independently operable from one or both of the photoluminescence imaging device 202 and/or the birefringent contrast imaging device 220. The confocal chromatic sensor may obtain data indicative of a distance to the semiconductor workpiece 240 and/or a thickness of the semiconductor workpiece 240 (e.g., to act as a depth sensor for the system). Additionally or alternatively, the photoluminescence imaging device 202 can be configured to be adjusted independent of the birefringent contrast imaging device 220 based on data received from the confocal chromatic sensor. In some embodiments, the confocal chromatic sensor and/or a separate illuminator can illuminate a face of the semiconductor workpiece 240.

In some embodiments, the illuminator 258 may include or be a part of a confocal chromatic sensor. The confocal chromatic sensor can focus a radiation source of at least one of the first or second imaging devices. The confocal chromatic sensor can be configured to be independently operable from one or both of the photoluminescence imaging device 202 and/or the birefringent contrast imaging device 220. The confocal chromatic sensor may obtain data indicative of a distance to the semiconductor workpiece 240 and/or a thickness of the semiconductor workpiece 240 (e.g., to act as a depth sensor for the system). Additionally or alternatively, the photoluminescence imaging device 202 can be configured to be adjusted independent of the birefringent contrast imaging device 220 based on data received from the confocal chromatic sensor. In some embodiments, the confocal chromatic sensor and/or a separate illuminator can illuminate a face of the semiconductor workpiece 240.

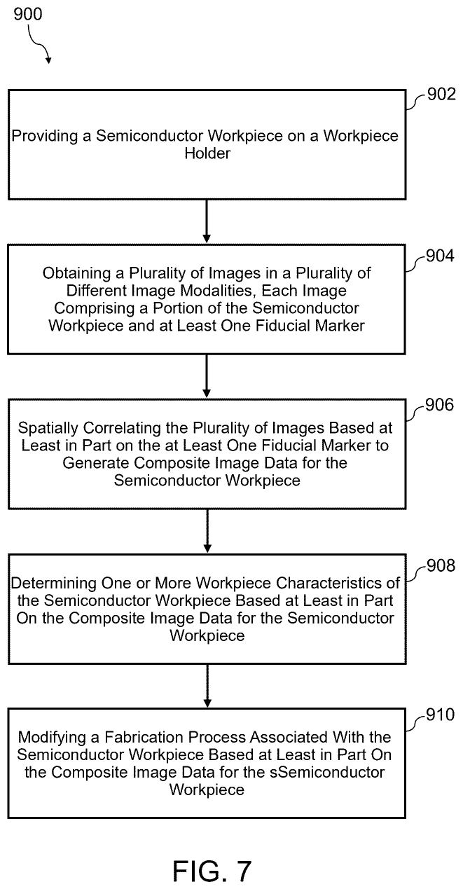

As will be discussed with reference to FIG. 7, the birefringent contrast imaging device 202 may have other suitable optical configurations, such as using telecentric lenses and mirrors to accommodate capturing images of on-axis and/or off-axis semiconductor workpieces.

For on-axis workpieces, the birefringent contrast imaging device 202 may provide incident light so that it is parallel to the optical axis of the workpiece (e.g., c-plane of a 4H or 6H silicon carbide workpiece) so that the polarization of the incident light is modified by the birefringent nature of the material. For on-axis workpieces (e.g., on-axis 4H or 6H silicon carbide) the incident light may be perpendicular to the workpiece. For off-axis workpieces (e.g., 4° off-axis 4H or 6H silicon carbide) the incident light may be off-axis relative to the workpiece (e.g., not perpendicular) so that the incident light is aligned or nearly aligned with the off-axis c-plane of the workpiece.

The photoluminescence imaging device 220 can include an ultraviolet radiation source 222, a photoluminescence detector 226, one or more second optical elements 254a-d, a light attenuator 262, a power meter 266, and/or an optical filter 270. The ultraviolet radiation source 222 can include a coherent radiation source, such as a laser. In some embodiments, the light attenuator 262 may be included to help modulate (e.g., reduce) an intensity of the ultraviolet radiation source 222. This may be valuable, for example, in situations where the laser output of the ultraviolet radiation source 222 is too strong for the semiconductor workpiece 240 or if precise control over the laser power is needed. Damaging the semiconductor workpiece 240 due to a laser intensity would be counterproductive to identifying and mitigating defects or other features on or in the semiconductor workpiece 240. The light attenuator 262 can absorb and/or scatter a portion of the laser light passing therethrough. This can reduce the beam intensity without significantly altering its properties such as its spatial and temporal characteristics.

In some embodiments, the photoluminescence imaging device 220 includes one or more of the second optical elements 254a-d shown. The optical elements 254a, 254b, 254d can include reflective optical elements, such as mirrors (e.g., dielectric mirrors, dichroic mirrors).

The reflective optical elements can be configured to reflect a particular wavelength or range of wavelengths. The optical element 254c may be a refractive optical element, such as a lens. The lens may be configured to be a focusing lens and/or a collimating lens. The second optical elements 254a-d can be helpful in controlling a shape, direction, and/or other characteristics of the beam of light from the ultraviolet radiation source 222. For example, in some examples, it may be desirable to align the beam of light from the ultraviolet radiation source 222 such that the incident angle of the beam relative to a flat surface of a semiconductor workpiece would be at a non-parallel incident angle relative to an axis normal to a major surface of the workpiece. For instance, it may be desirable to align the beam of light to be within 10% to the Brewster angle of the semiconductor workpiece material. Additionally, it may be ideal to shape the beam according to the incident angle such that the intensity of the beam is uniform in the area of contact on the surface of the semiconductor workpiece and/or the area of contact on the semiconductor workpiece can be modified in relation to the field of view of the photoluminescence detector 226. In some embodiments, the controller (not shown) can automatically control one or more of the second optical elements 254a-d (and/or the first optical elements 250a-d).

The photoluminescence detector 226 may be configured to detect photoluminescence, such as fluorescence. The photoluminescence detector 226 can include one or more of photomultiplier tubes, avalanche photodiodes, a CCD sensor, and/or a CMOS sensors. The photoluminescence detector 226 may be configured to detect one or more ranges of fluorescence, such as about 400-500 nm (e.g., blue emissions), about 500-600 nm (e.g., green emissions), about 600-700 nm (e.g., red emissions), about 700-1100 nm (e.g., infrared emissions). As indicated in FIG. 3, the photoluminescence detector 226 may be configured to be movable along one or more degrees of freedom. For example, the photoluminescence detector 226 may be translatable along a z-axis. Other degrees of freedom, such as x-and/or y-axis translations may be possible. In some embodiments, the photoluminescence detector 226 can be rotated along one or more of the x-, y-, and/or z-axis. The controller may be configured to control these movements.

In some embodiments, the photoluminescence detector 226 can include the optical filter 270. The optical filter 270 may include a filter wheel including a plurality of optical filters, such as wavelength range filters. The optical filter 270 may be controllable by the controller. In some embodiments, the optical filter 270 includes filters for one or more of the ranges of fluorescence (e.g., blue fluorescence, green fluorescence, red fluorescence, infrared fluorescence) described above. FIG. 3. depicts an example where the optical filter 270 may include an optical wheel with a plurality of optical filters which provides the system the ability to customize filter selection and allow an image to be scanned with multiple filters. This is advantageous for the optimization of multiple defect class detection, and/or increased defect detection by combining data from multiple filters for certain defect classes.

In some embodiments, the semiconductor workpiece inspection system 200 can include a power meter 266. The power meter 266 can measure and in some embodiments control (e.g., at the direction of the controller) a power output by the radiation source 204 and/or from the ultraviolet radiation source 222. The power meter 266 can include a sensor that tracks an amount of power provided by the target radiation source (e.g., the infrared radiation source 204, the ultraviolet radiation source 222). In some embodiments, the power meter 266 can additionally or alternatively serve as a light attenuator to provide a minimum or maximum power intensity of the target radiation source. The power meter 266 may measure the power intensity electrically or optically. For example, the power meter 266 may be in electrical communication with the radiation source to measure and/or control the power intensity of the radiation source. Additionally or alternatively, the power meter 266 may receive a portion (e.g., a split portion) of the incident polarized light 210 and/or the transmitted light 212 to determine an optical intensity of the light. In some embodiments, the power meter 266 can increase or decrease the intensity output by the power meter 266. Modifying the intensity of the output light can help ensure that the semiconductor workpiece 240 is not damaged by an overly intense incident polarized light 210. Additionally or alternatively, the power meter 266 can help ensure that the transmitted light 212 is sufficiently intense that the optical detector 208 can pick up the signal of the features during imaging.

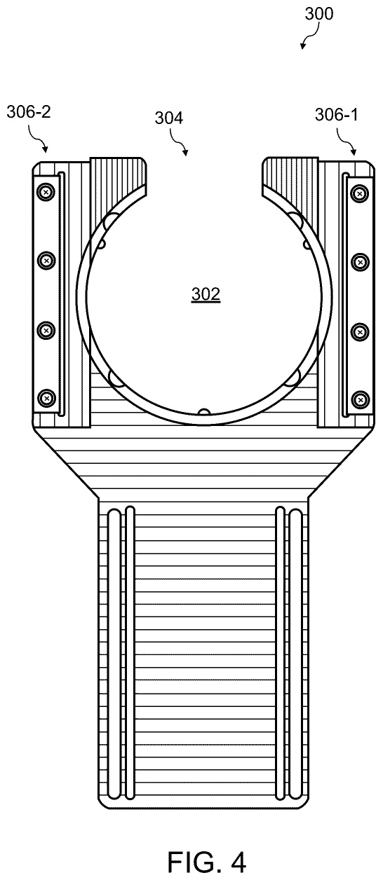

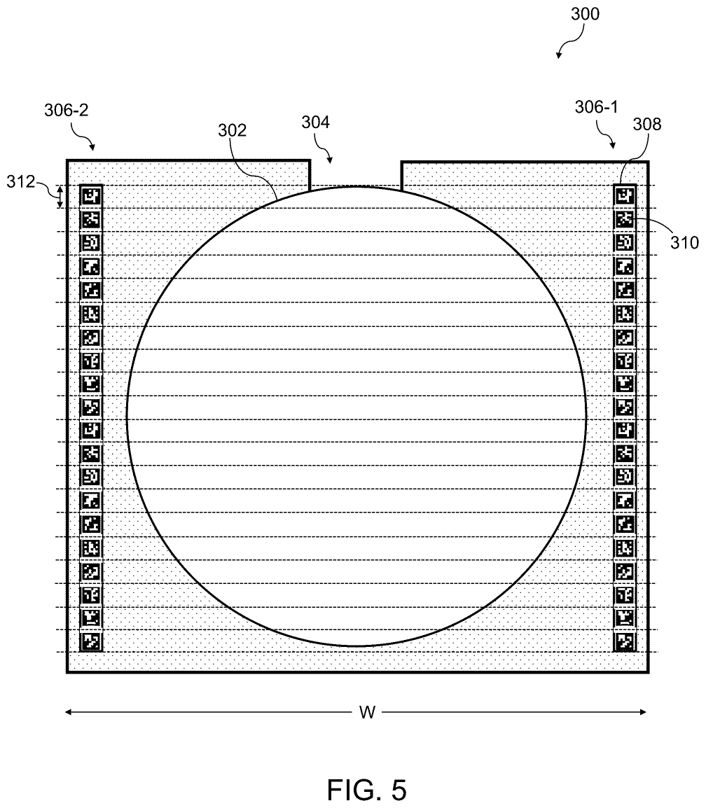

FIGS. 4-5 depict an example workpiece holder 300 according to example embodiments of the present disclosure. More particularly, FIG. 4 depicts a top perspective view of the example workpiece holder 300, and FIG. 5 depicts a close-up plan view of a top portion of the example workpiece holder 300. It should also be understood that FIGS. 4-5 are intended to represent structures for purposes of identification and description and are not intended to represent the structures to physical scale.

The example workpiece holder 300 depicted in FIGS. 4-5 may be similar to any of the workpiece holders described herein, such as the workpiece holder 248 discussed above with reference to FIGS. 1-3. For instance, the workpiece holder 300 may be operable to hold and/or support a workpiece 302. More particularly, as shown, the workpiece holder 300 may include a receptacle 304 operable to receive the workpiece 302. It should be understood that the workpiece 302 may be similar to any of the workpieces described herein, such as the semiconductor workpiece 140 (FIG. 1), the semiconductor workpiece 240 (FIGS. 2-3), and/or the like.

The workpiece holder 300 may also include one or more fiducial structures 306, such as a first fiducial structure 306-1 and a second fiducial structure 306-2 (collectively “fiducial structure(s) 306”). Those having ordinary skill in the art, using the disclosures provided herein, will appreciate that the fiducial structure 306 may be similar to any of the fiducial structures described herein, such as the fiducial structure 144 (FIG. 1), the fiducial structure 244 (FIGS. 2-3), and/or the like. In some examples, each fiducial structure 306 may be on a peripheral side of the workpiece holder 300. For instance, as shown in FIGS. 4-5, the first fiducial structure 306-1 may be on a peripheral side of the workpiece holder 300, and the second fiducial structure 306-2 may be on an opposing peripheral side of the workpiece holder 300 from the first fiducial structure 306-1. Put differently, the workpiece holder 300 may be configured such that the receptacle 304 and, hence, the workpiece 302 may be between the first fiducial structure 306-1 and the second fiducial structure 306-2.

The fiducial structures 306 may include a semiconductor structure 308. The semiconductor structure 308 may include a semiconductor material. In some examples, the semiconductor structure 308 may include the same semiconductor material as the workpiece 302. By way of non-limiting example, the semiconductor structure 308 may include a wide bandgap semiconductor, such as silicon carbide (SiC). However, those having ordinary skill in the art, using the disclosures provided herein, will appreciate that the semiconductor structure 308 may include any suitable semiconductor material without deviating from the scope of the present disclosure.

The fiducial structures 306 may further include one or more fiducial markers 310 on the semiconductor structure 308. In some examples, each of the one or more fiducial markers 310 may include at least one of an ArUco pattern, an AprilTag pattern, a CALTag pattern, an ARTag pattern, and/or the like. It should be understood that the fiducial structures 306 are depicted as having one column of fiducial markers 310 for purposes of illustration and discussion. Those having ordinary skill in the art, using the disclosures provided herein, will understand that a fiducial structure of the present disclosure may include any number of fiducial markers having any suitable pattern without deviating from the scope of the present disclosure.

As will be discussed in greater detail below, each fiducial marker 310 may include an internal first region of a material of first optical characteristics and a second region at least partially around the internal first region. The second region may be a material having second optical characteristics that are different from the first optical characteristics. In some examples, the first region may transmit light in a transmission-based light imaging modality (e.g., birefringent contrast imaging modality). The second region may not transmit light in the transmission-based light imaging modality (e.g., birefringent contrast imaging modality). The first region may emit light in an emission-based light imaging modality (e.g., photoluminescence imaging modality). The second region may not emit light in an emission-based light imaging modality (e.g., photoluminescence imaging modality). The first region may not reflect light in a reflection-based imaging modality. The second region may reflect light in the reflection-based imaging modality. In some examples, the first region is a non-blocking region, and the second region is a blocking region comprising a metal region. However, other suitable materials may be used for the second region, such as ceramic materials (e.g., ZnO, ZnS) without deviating from the scope of the present disclosure.

In some examples, the first region is an internal non-blocking region, and the second region is a blocking region at least partially around the internal non-blocking region. The first region is referred to as a “non-blocking” region because for a transmission-based imaging modality (e.g., birefringent contrast imaging), the non-blocking region may not block light incident on the fiducial marker at the wavelength of light incident on the workpiece. The second region is referred to as a “blocking region” because for a transmission-based imaging modality (e.g., birefringent contrast imaging modality), the blocking region may block light incident on the fiducial marker at the wavelength(s) of light incident on the workpiece.

The blocking region of each fiducial marker 310 may include a metal. However, in some embodiments, the blocking region may be another blocking material, such as a ceramic material, such as ZnO, ZnS, or the like. The internal non-blocking region of each fiducial marker 310 may include a non-metal material, such as silicon nitride (SiN), a phosphor material, and/or the like. The internal non-blocking region of each fiducial marker 310 may be transmissive to incident light when imaged by an imaging device, such as any of the imaging devices described herein; the blocking region of each fiducial marker 310 may be non-transmissive and/or non-emissive when imaged by an imaging device, such as any of the imaging devices described herein. For instance, in some examples, the internal non-blocking region of each fiducial marker 310 may emit light when exposed to ultraviolet radiation, and the blocking region of each fiducial marker 310 may be non-emissive of light when exposed to ultraviolet radiation. In this way, the one or more fiducial markers 310 may be detectable in a plurality of different image modalities, such as a birefringent contrast image modality, a photoluminescence image modality, and/or the like.

As described above, the fiducial structures 306 may be used by an inspection system (e.g., semiconductor workpiece inspection system 100 (FIG. 1), semiconductor workpiece inspection system 200 (FIGS. 2-3)) to spatially correlate a plurality of images of the workpiece 302. More particularly, an example inspection system may include one or more imaging devices (e.g., first imaging device 102 and second imaging device 120 (FIG. 1), birefringent contrast imaging device 202 and a photoluminescence imaging device 220 (FIGS. 2-3), etc.). The one or more imaging devices may be operable to obtain a plurality of images 312 in a plurality of different image modalities by scanning a width W of the workpiece 302 between the first fiducial structure 306-1 and the second fiducial structure 306-2, and each image 312 may include a portion of the workpiece 302 and at least one fiducial marker 310. For instance, in some examples, the example inspection system may be operable to determine spatial coordinates for each image of the plurality of images (e.g., based at least in part on the at least one fiducial marker 310 included in each respective image) in each image modality of the plurality of image modalities. In such examples, the inspection system may be further operable to spatially correlate each image of the plurality of images in each image modality of the plurality of image modalities based at least in part on the respective spatial coordinates of each image. In this way, the fiducial structures 306 may serve as an anchor point and/or reference point for determining the spatial coordinates of the plurality of images. It should be understood that, although depicted as including only one fiducial marker 310, each image 312 may include any number of fiducial markers 310 without deviating from the scope of the present disclosure.

By way of non-limiting example, the one or more imaging devices may obtain a plurality of first modality images and a plurality of second modality images. Each first modality image may include a portion of the workpiece 302 and at least one fiducial marker 310 in a first image modality, such as a birefringent contrast image modality. Similarly, each second modality image may include a portion of the workpiece 302 and at least one fiducial marker 310 in a second image modality, such as a photoluminescence image modality.

The inspection system may be operable to generate first composite image data for the workpiece 302 by spatially correlating (e.g., aligning) the plurality of first modality images based at least in part on the fiducial markers 310 (e.g., based at least in part on light emitted from the internal non-blocking region of the at least one fiducial marker 310 in the first image modality). As described above, the first composite image data may depict and/or otherwise be associated with the workpiece 302 in the first image modality (e.g., birefringent contrast image modality). For instance, in some examples, the first composite image data for the workpiece 302 may be and/or may include a first composite image of the workpiece 302 that visually depicts the workpiece 302 in the first image modality.

The inspection system may also be operable to generate second composite image data for the workpiece 302 by spatially correlating (e.g., aligning) the plurality of second modality images based at least in part on the fiducial markers 310 (e.g., based at least in part on light emitted from the internal non-blocking region of the at least one fiducial marker 310 in the second image modality). As described above, the second composite image data may depict and/or otherwise be associated with the workpiece 302 in the second image modality (e.g., photoluminescence image modality). For instance, in some examples, the second composite image data for the workpiece 302 may be and/or may include a first composite image of the workpiece 302 that visually depicts the workpiece 302 in the second image modality.

Moreover, in some examples, the inspection system may also be operable to generate third composite image data for the workpiece 302 by spatially correlating (e.g., aligning) the first composite image data and the second composite image data (e.g., based at least in part on light emitted from the internal non-blocking region of the at least one fiducial marker 310 in the first image modality and the second image modality). As described above, the third composite image data may be multi-modality (e.g., multi-mode) image data that includes the first composite image data (e.g., associated with the first image modality) and the second composite image data (e.g., associated with the second image modality). For instance, in some examples, the third composite image data for the workpiece 302 may be and/or may include a third composite image of the workpiece 302 that visually depicts the workpiece 302 in the first image modality (e.g., birefringent contrast image modality) and in the second image modality (e.g., photoluminescence image modality).

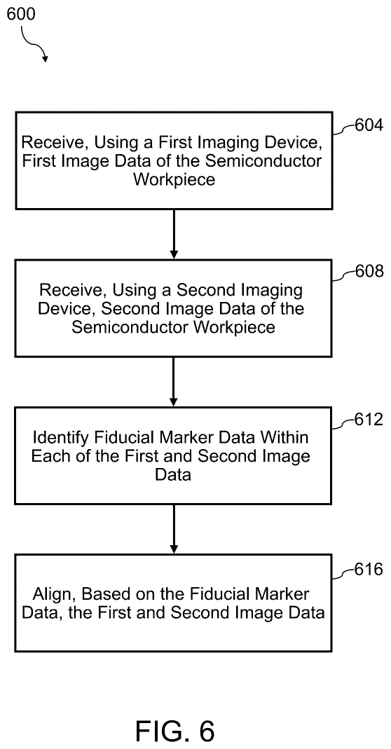

FIG. 6 depicts an example method 600 that can be performed, for instance, by one or more systems (e.g., the semiconductor workpiece inspection system 100, the semiconductor workpiece inspection system 200) and/or controllers of said systems (e.g., the controller 132, the controller 232), according to certain embodiments. FIG. 6 depicts operations performed in a particular order for purposes of illustration and discussion. Those of ordinary skill in the art, using the disclosures provided herein, will understand that the various operations of any of the methods or processes described herein may be adapted, rearranged, omitted, include steps not illustrated, and/or modified in various ways without deviating from the scope of the present disclosure.

At 604, the system can receive, using a first imaging device, first image data of a semiconductor workpiece. The first imaging device may include a first imaging device 102 and/or a birefringent contrast imaging device 202 described herein. Other imaging devices described herein are possible. For example, the second imaging device can include a birefringent contrast imaging device, and the method 600 may include imaging, using the birefringent contrast imaging device, the semiconductor workpiece using polarized light directed at the semiconductor workpiece. Additionally or alternatively, the system can detect, using the birefringent contrast imaging device, a light signal transmitted through the semiconductor workpiece.

In some embodiments, the first imaging device comprises a coherent radiation source that is configured to emit coherent polarized light. The method 600 can include causing the coherent radiation source to generate despeckled light.

At 608, the system can receive, using a second imaging device, second image data of the semiconductor workpiece. The second imaging device can include any imaging device described herein, such as the second imaging device 120 and/or the photoluminescence imaging device 220. Receiving the second image data of the semiconductor workpiece can include imaging the semiconductor workpiece using ultraviolet light directed at the semiconductor workpiece. Additionally or alternatively, receiving the second image data of the semiconductor workpiece can include detecting, using the photoluminescence imaging device, photoluminescence (e.g., fluorescence) emitted from the semiconductor workpiece.

In some embodiments, the system can modify, using a light attenuator, an intensity of the ultraviolet light. Additionally or alternatively, the system can indicate, using a power meter, an intensity of the ultraviolet light. In some embodiments, the power meter may indicate that the intensity of the ultraviolet light is too high, and the system may automatically reduce an intensity of the ultraviolet light. Additionally or alternatively, the power meter may indicate that the intensity of the ultraviolet light is too low and the system may automatically increase an intensity of the ultraviolet light. The system may detect, using a fluorescence detector (e.g., the photoluminescence detector 226), fluorescence emitted from the semiconductor workpiece.

At 612, the system can adjust one or more imaging parameters of the first imaging device independently of the second imaging device. Such imaging parameters can include one or more of a focal length of a refractive optical element, a scanning speed of an imaging device, a type of light (e.g., wavelength), an intensity of radiation, image modality, contrast mechanism, (darkfield, bright field, DIC, etc.), sensor type, or similar parameter. In some embodiments, the system can identify fiducial marker data within each of the first and second image data. In some embodiments, the system can spatially correlate, based on the fiducial marker data, the first and second image data. In some embodiments, spatially correlating the first and second image data includes setting a first viewpoint of the first imaging device at a first portion of the semiconductor workpiece and/or setting a second viewpoint of the second imaging device at a second portion of the semiconductor workpiece. In some embodiments, spatially correlating the first and second image data includes mapping, based on the fiducial marker data, the semiconductor workpiece along three orthogonal axes. In some embodiments, spatially correlating the first and second image data includes focusing the first imaging device at a first portion of the semiconductor workpiece and/or focusing the second imaging device at a second portion of the semiconductor workpiece.

In some embodiments, the method 600 includes mapping, using a confocal chromatic sensor, a focus of a radiation source of at least one of the first or second imaging devices. The confocal chromatic sensor can be configured to be independently operable from the first and second imaging devices. For example, the confocal chromatic sensor may obtain data indicative of a distance to the semiconductor workpiece or a thickness of the semiconductor workpiece. Additionally or alternatively, the first channel can be configured to be adjusted independent of the second channel based on data received from the confocal chromatic sensor. In some embodiments, the system can illuminate, using an illuminator, a face of the semiconductor workpiece.

In some embodiments, the system can receive the first and second image data simultaneously. Alternatively, the system may receive the first and second image data sequentially.

The system may generate, based on the fiducial marker data, a map of the semiconductor workpiece along three orthogonal axes. Additionally or alternatively, the system may store the map and later and/or as needed access the stored map. In some embodiments, the system can spatially correlate, based on the stored map, at least one of the first or second imaging devices with pixel-level accuracy.

In some embodiments, the system can include a third imaging device, such as one

described herein. The method 600 can include imaging, using the third imaging device having a third radiation source, the semiconductor workpiece. Additionally or alternatively, the method 600 can include generating, using the third imaging device, a darkfield image. Additionally or alternatively, the method 600 can include generating, using the third imaging device, a brightfield image using reflected light.

FIG. 7 depicts an example optical system 700 that can be used as a birefringent inspection system, such as the birefringent contrast imaging device 202 depicted in FIG. 3. The optical system 700 can include a radiation source 704, a first refractive optical element 708, a first reflective optical element 712, a second reflective optical element 716, a second refractive optical element 720, and/or an optical detector 724. The optical system 700 can image a semiconductor workpiece 732. The semiconductor workpiece 732 may be supported by a workpiece holder 728.

The radiation source 704 can include any radiation source described herein. The radiation source 704 can include one or more features of specific example radiation sources described in detail herein (e.g., the first radiation source 104, the second radiation source 122, the infrared radiation source 204, the ultraviolet radiation source 222). The radiation source 704 can include a telecentric illuminator. For example, the radiation source 704 can be used to provide light for one or more imaging types, such as photoelastic imaging.

Photoelastic (e.g., cross-polarized) imaging is a common technique for visualizing stress in transparent materials. 4H-SiC wafers are a transparent material, and cross-polarized images are used as a normal part of quality control for 4H-SiC wafers. However, due to the off-axis cut of 4H-SiC wafers intended for some example power devices (e.g., 4-degress offcut), the photoelastic images of this high-volume product may be of limited quality. Reference to wafers can refer to any of the semiconductor workpieces described herein, such as the semiconductor workpiece 140, the semiconductor workpiece 240, and/or the semiconductor workpiece 732.

It may be valuable to address such wafer deficiencies using a cross-polarized imaging apparatus that has the following properties: collimation and aligned with the wafer axis. Regarding collimation, all light entering the wafer and being collected by the inspection system can be collimated. This means that a ray of light in the system emerges from a point source, goes through the wafer, and then is collected by demagnification. It can later be un-bent by a subsequent lens. Regarding alignment with the wafer axis, the light used to image the wafer can be aligned with the crystallographic axis of the wafer.

Embodiments disclosed herein can have these properties, which may allow for rapid reconfiguration of the measurement of the wafers of any off-axis orientation (or on-axis). These properties can be achieved in various ways, for example, regarding collimation, a telecentric illuminator can be utilized to provide light to a telecentric lens that collects it and projects it onto an image sensor.

Use of linescan cameras and movable stages to translate the wafer can be very advantageous. Area scan cameras may have concomitant problems. For example, deformation due to use of rotating mirrors can occur. This may occur because the wafer can be oval shaped in the image rather than circular due to the difference in optical path produced by the rotating mirrors. Additionally or alternatively, such systems may defocus across the image. This can occur because the depth of field of an area scan camera may be finite. Optimizing the focus to work well in the center of the wafer may cause the left or right sides of the wafer to be out of focus, again due to optical path difference. Effectively, the left side of the wafer would be “closer” to the image sensor and the right side would be “further away”.

These problems can be solved by using a linescan camera. The linescan camera's single line of pixels can be placed in the “center” of the system's optical axis (e.g., the single point in focus), allowing the system to achieve tight focus over the entire wafer. Because the linescan camera is triggered by the encoder pulses of the moving stage, it images the wafer in real space rather than the elongated space produced by the movable mirrors. In this way the images of the wafers that are produced will be circular with no special correction effort required.

Variations may be made to any of the inspection systems provided herein without deviating from the scope of the present disclosure. For instance, in some embodiments, the workpiece holder can utilize an x-y stage and/or include higher magnification optics to achieve a higher resolution. In some embodiments, the optical system (e.g., the semiconductor workpiece inspection system 100, the semiconductor workpiece inspection system 200) does not include any polarizing optical elements in front of an optical detector (e.g., the first detector 108, the second detector 126, the sensor 150, the optical detector 208, the photoluminescence detector 226). Additionally or alternatively, the optical system can include a polarimetric linescan camera (e.g., a Teledyne-Dalsa Pihranha4 Polarization) to produce a full-stokes image of the wafer for higher sensitivity to strain. In some embodiments, one or more dichroic mirrors and/or other illumination source at a wavelength different from those used to make the cross-polarized image to produce a simultaneous image of the wafer surface (e.g., utilizing a darkfield source with violet illumination and/or a green illumination being used to produce the cross-polarized image) can be used. In some embodiments, an off-axis linescan camera to produce the same effect as listed above can be used. In some embodiments, this will omit or reduce the use of dichroic mirrors. In such embodiments, it may be possible for collimated illumination and light collection not to be used.

FIG. 7 depicts a flow chart diagram of an example method 900 according to example embodiments of the present disclosure. FIG. 7 depicts example process steps for purposes of illustration and discussion. Those having ordinary skill in the art, using the disclosures provided herein, will understand that the process steps of any of the methods described in the present disclosure may be adapted, modified, include steps not illustrated, omitted, and/or rearranged without deviating from the scope of the present disclosure.

At 902, the method 900 includes providing a semiconductor workpiece on a workpiece holder. The semiconductor workpiece may have a hexagonal crystal structure. In some examples, the semiconductor workpiece may include a wide bandgap semiconductor, such as silicon carbide (SiC) and/or the like. In some examples, the semiconductor workpiece may include at least one fiducial structure. Additionally and/or alternatively, in some examples, the workpiece holder may include at least one fiducial structure. By way of non-limiting example, as described above, a first fiducial structure may be provided on a peripheral side of the workpiece holder, and a second fiducial structure may be provided on an opposing peripheral side of the workpiece holder from the first fiducial structure.

As discussed above, the fiducial structure may include a semiconductor structure and at least one fiducial marker. In some examples, each fiducial marker may be on the semiconductor structure. In some examples, the semiconductor structure may include the same semiconductor material as the semiconductor workpiece, such as the same wide bandgap semiconductor material (e.g., silicon carbide (SiC), etc.). Furthermore, each fiducial marker may include at least one of an ArUco pattern, an AprilTag pattern, a CALTag pattern, an ARTag pattern, and/or the like.

Each fiducial marker may include an internal first region of a material of first optical characteristics and a second region at least partially around the internal first region. The second region may be a material having second optical characteristics that are different from the first optical characteristics. In some examples, the first region may transmit light in a transmission-based light imaging modality (e.g., birefringent contrast imaging modality). The second region may not transmit light in the transmission-based light imaging modality (e.g., birefringent contrast imaging modality). The first region may emit light in an emission-based light imaging modality (e.g., photoluminescence imaging modality). The second region may not emit light in an emission-based light imaging modality (e.g., photoluminescence imaging modality). The first region may not reflect light in a reflection-based imaging modality. The second region may reflect light in the reflection-based imaging modality.

In some examples, the fiducial structure of the fiducial marker may include a semiconductor structure that is the same semiconductor material as the semiconductor workpiece. In some examples, the optical axis of the semiconductor structure of the fiducial structure may match or align with the optical axis of the semiconductor workpiece. For instance, in the case of silicon carbide having a hexagonal crystal structure. The c-axis of the hexagonal crystal structure should align with a c-axis of the hexagonal crystal structure of the semiconductor structure of the at least one fiducial marker. For instance, if the semiconductor workpiece is on-axis 4H or 6H silicon carbide, the semiconductor structure of the fiducial structure may be on axis 4H or 6H silicon carbide. If the semiconductor workpiece is off-axis 4H or 6H silicon carbide, the semiconductor structure of the fiducial structure may be off-axis 4H or 6H silicon carbide. The c-axis of the off-axis silicon carbide of the semiconductor workpiece may be aligned or match with the c-axis of the off-axis semiconductor structure of the fiducial structure.

In the event, the optical axes of the semiconductor workpiece and the fiducial structure are not aligned, aspects of the present disclosure may modify the application of incident light on the semiconductor workpiece and the fiducial structure so that they are effectively aligned. For instance, if the semiconductor workpiece is on-axis 4H or 6H silicon carbide and the fiducial structure comprises off-axis 4H or 6H silicon carbide, the angle of incidence on the light on the workpiece may be generally perpendicular to the workpiece but provided at a non-perpendicular angle to the fiducial structure so that the incident light is affected by birefringent properties of both the on-axis silicon carbide workpiece and the off-axis silicon carbide fiducial structure.

In some examples, a first plurality of fiducial markers may be provided on a first end of the workpiece holder, and a second plurality of fiducial markers may be provided on a second end of the workpiece holder that is opposite the first end of the workpiece holder. In such examples, the semiconductor workpiece may be provided between the first end of the workpiece holder and the second end of the workpiece holder.

At 904, the method 900 includes obtaining a plurality of images in a plurality of different image modalities, each image including a portion of the semiconductor workpiece and at least one fiducial marker. The plurality of images in the plurality of different image modalities may be obtained from one or more imaging devices. In some examples, the one or more imaging devices may include one or more line-scan cameras. More particularly, to obtain each image of the plurality of images in the plurality of different modalities, a width of the semiconductor workpiece may be scanned between a first fiducial marker on a first end of the semiconductor workpiece to a second fiducial marker on a second end of the semiconductor workpiece that is opposite the first end. As discussed above, the at least one fiducial marker may include an internal non-blocking region and a blocking region at least partially around the non-blocking region. The internal non-blocking region may emit light when exposed to ultraviolet radiation, and the blocking region may be non-emissive of light when exposed to the ultraviolet radiation. More particularly, the internal non-blocking region may include a non-blocking material (e.g., silicon nitride, a phosphor material, etc.), and the blocking region may include a metal.

In some examples, a plurality of first modality images may be obtained, and each first modality image may include a portion of the semiconductor workpiece and the at least one fiducial marker in a first image modality. Furthermore, a plurality of second modality images may be obtained, and each second modality image may include a portion of the semiconductor workpiece and the at least one fiducial marker in a second image modality that is different form the first image modality. By way of non-limiting example, the first image modality may be a birefringent contrast image modality, and the second image modality is a photoluminescence image modality.

In some examples, the one or more imaging devices may be focused based on one or more resolution markers adjacent the at least one fiducial marker, and the one or more imaging devices may obtain the plurality of images. As described above, the one or more resolution markers may include the same metal as the blocking region of the at least one fiducial marker. By way of non-limiting example, the one or more resolution markers may be one or more Ronchi rulings, such as one or more Ronchi rulings corresponding to a 1951 USAF resolution test chart. It should be understood the one or more resolution markers may be any suitable resolution marker without deviating from the scope of the present disclosure.

At 906, the method 900 includes spatially correlating the plurality of images based at least in part on the at least one fiducial marker to generate composite image data for the semiconductor workpiece. More particularly, spatial coordinates for each image of the plurality of images may be determined based at least in part on the at least one fiducial marker included in each respective image. Moreover, each image of the plurality of images, in each image modality of the plurality of image modalities, may be spatially correlated (e.g., aligned) based at least in part on the spatial coordinates of each respective image.

As described above, in some examples, the at least one fiducial marker may include an internal non-blocking region that emits light when exposed to ultraviolet radiation and a blocking region that is non-emissive of light when exposed to ultraviolet radiation. In some examples, the plurality of images may be spatially correlated and/or aligned based at least in part on the light emitted from the internal non-blocking region of the at least one fiducial marker.

In some examples, a plurality of first modality images depicting the semiconductor workpiece in a first image modality may be obtained, and a plurality of second modality images depicting the semiconductor workpiece in a second image modality may likewise be obtained. In such examples, first composite image data for the semiconductor workpiece may be generated by spatially correlating the plurality of first modality images based at least in part on the at least one fiducial marker, and second composite image data for the semiconductor workpiece may be generated by spatially correlating the plurality of second modality images based at least in part on the at least one fiducial marker. As described above, the first composite image data may depict and/or otherwise be associated with the semiconductor workpiece in the first image modality (e.g., birefringent contrast modality), and the second composite image data may depict and/or otherwise be associated with the semiconductor workpiece in the second image modality (e.g., photoluminescence modality). For instance, in some examples, the first composite image data may be and/or may include a first composite image of the semiconductor workpiece that visually depicts the semiconductor workpiece in the first image modality, and the second composite image data may be and/or may include a second composite image of the semiconductor workpiece that visually depicts the semiconductor workpiece in the second image modality. In some examples, third composite image data for the semiconductor workpiece may be generated by spatially correlating the first composite image data and the second composite image data. As described above, the third composite image data may be multi-modality (e.g., multi-mode) image data comprising the first composite image data (e.g., associated with the first image modality) and the second composite image data (e.g., associated with the second image modality). For instance, in some examples, the third composite image data may be and/or may include a third composite image of the semiconductor workpiece that visually depicts the semiconductor workpiece in the first image modality and the second image modality.

Additionally and/or alternatively, in some examples, sensor data from one or more depth sensors (e.g., illuminators, CCS, ultrasonic sensors, etc.) may be obtained, and a depth between the one or more imaging devices and the semiconductor workpiece may be determined based at least in part on the sensor data. In such examples, composite image data for the semiconductor workpiece may be generated by spatially correlating each of the plurality of images based at least in part on the at least one fiducial marker and the depth between the one or more imaging devices and the semiconductor workpiece.

Additionally and/or alternatively, in some examples, reference plane coordinates for the workpiece holder may be determined based on the at least one fiducial marker, and a motion error may be determined for each of the plurality of images based on the reference plane coordinates for the workpiece holder and the at least one fiducial marker. In some examples, to determine the motion error for each of the plurality of images, a framing offset and/or an image overlap between each of the plurality of images may be determined based on the reference plane coordinates for the workpiece holder and the at least one fiducial marker. In such examples, composite image data for the semiconductor workpiece may be generated by spatially correlating each of the plurality of images based at least in part on the motion error for each of the plurality of images and the at least one fiducial marker.

At 908, the method 900 optionally includes determining one or more workpiece characteristics of the semiconductor workpiece based at least in part on the composite image data for the semiconductor workpiece. For instance, in some examples, one or more defects associated with the semiconductor workpiece may be determined based at least in part on the composite image data (e.g., generated at 906). Additionally and/or alternatively, in some examples, a surface roughness of the semiconductor workpiece may be determined based at least in part on the composite image data (e.g., generated at 906). Additionally and/or alternatively, in some examples, a parallelism of the semiconductor workpiece may be determined based at least in part on the composite image data (e.g., generated at 906). Additionally and/or alternatively, in some examples, an optical wedge of the semiconductor workpiece may be determined based at least in part on the composite image data (e.g., generated at 906).

At 910, the method 900 optionally includes modifying a fabrication process associated with the semiconductor workpiece based at least in part on the composite image data for the semiconductor workpiece. For instance, in some examples, a surface processing process associated with the semiconductor workpiece (e.g., grinding process, lapping process, polishing process, etc.) may be modified based at least in part on the composite image data for the semiconductor workpiece. Additionally and/or alternatively, in some examples, a crystal growth process associated with the semiconductor workpiece may be modified based at least in part on the composite image data for the semiconductor workpiece. Additionally and/or alternatively, in some examples, feedback data associated with the fabrication process may be generated based at least in part on the composite image data for the semiconductor workpiece (e.g., generated at 906). The feedback data may be indicative of one or more defects associated with the fabrication process. As such, the fabrication process associated with the semiconductor workpiece may be modified based at least in part on the feedback data, such as by identifying the semiconductor workpiece for a different fabrication operation to address the one or more defects associated with the feedback data, modifying a prior fabrication operation to reduce future anomalies and/or defects, determining whether to discard the semiconductor workpiece, and/or the like.

In some examples, the method 900 may include both operations 908 and operation 910. In some examples, the method may include operation 908 without including operation 910. For instance, the method may include determining one or more workpiece characteristics without modifying fabrication. In some examples, the method may include operation 910 without including operations 908. For instance, the method may include modifying fabrication without determining one or more workpiece characteristics.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

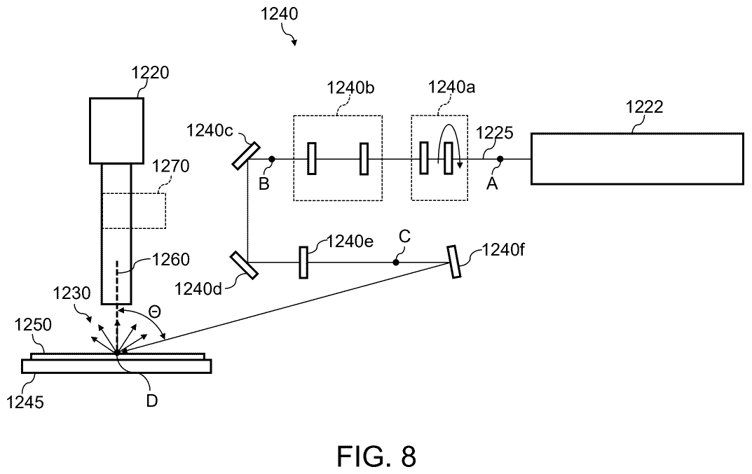

FIG. 8 depicts an example workpiece inspection system 1000 according to examples of the present disclosure. In some examples, the workpiece inspection system 1000 is a photoluminescence based inspection system used to obtain photoluminescence imaging of a semiconductor workpiece, such as a silicon carbide semiconductor workpiece. However, in some embodiments, the workpiece inspection system 1000 can be configured to capture other types of images, such as darkfield images of the semiconductor workpiece.

The workpiece inspection system 1000 can include a radiation source 1222, such as an ultraviolet radiation source, such as an ultraviolet laser source. The radiation source 1222 may be configured to provide electromagnetic radiation 1225 (e.g., coherent ultraviolet radiation) to a semiconductor workpiece 1250. In some embodiments, ultraviolet radiation can have a wavelength in a range of about 300 nm to about 400 nm, such as about 350 nm to about 400 nm, such as about 385 nm to about 400 nm, such as about 355 nm, such as about 308 nm, etc.

The semiconductor workpiece 1250 may be, in some embodiments, a silicon carbide semiconductor workpiece. However, other workpieces of different materials are contemplated without deviating from the scope of the present disclosure.

The workpiece inspection system 1000 can include an imaging device 1220. The imaging device 1220 may be configured to capture an image of at least a portion of a semiconductor workpiece 1250. In some embodiments, the imaging device 1220 may include a photoluminescence detector configured to capture light 1230 associated with a photoluminescent response of the semiconductor workpiece 1250 to the electromagnetic radiation 1225 from the radiation source 1222. The imaging device 1220 can be and/or can include any of the imaging devices and/or detectors described herein, such time delay integration sensor, line scan detector, etc.

In some embodiments, the workpiece inspection system 1000 can include an optical path 1240 having one or more optical elements 1240a, 1240b, 1240c, 1240d, 1240e, 1240f, . . . etc. The optical path 1240 may provide the electromagnetic radiation 1225 (e.g., coherent ultraviolet radiation) from the radiation source 1222 to the workpiece 1250. The optical path 1240 can include any number of optical elements and/or optical devices to shape or direct the electromagnetic radiation 1225 without deviating from the scope of the present disclosure.

In some embodiments, the workpiece inspection system 1000 may provide the electromagnetic radiation 1225 at an incident angle θ to the semiconductor workpiece 1250. The incident angle θ may be relative to an axis 1260 normal to a major surface of the semiconductor workpiece 1250. In some embodiments, the incident angle θ is non-parallel to the axis 1260 normal to a major surface of the semiconductor workpiece 1250. In some embodiments, the incident angle θ may be about 45° or greater, such as about 60° or greater, such as about 65° or greater, such as about 70° or greater, such as in a range of about 45° to about 85°, such as in a range of about 60° to about 85° such as in a range of about 65° to about 85°, such as about 70° to about 85°.

In some embodiments, the incident angle θ may be selected to increase a photoluminescent response of the semiconductor workpiece 1250 to the electromagnetic radiation 1225 from the radiation source 1222 (e.g., increase the photoluminescent response relative an incident angle θ parallel to an axis 1260 normal to a major surface of the semiconductor workpiece 1250). For instance, in some embodiments, the incident angle θ may be within about 20° of a Brewster angle for the semiconductor workpiece 1250, such as within about 10° of a Brewster angle for the semiconductor workpiece 1250, such as within about 5° of a Brewster angle for the semiconductor workpiece 1250. Providing the electromagnetic radiation 1225 at an incident angle θ close to the Brewster angle will reduce reflection of the electromagnetic radiation 1225 from the surface of the semiconductor workpiece 1250, leading to increased transmission/absorption of the electromagnetic radiation 1225 by the semiconductor workpiece 1250 and increased photoluminescent response of the semiconductor workpiece 1250. This may provide stronger signals for the imaging device 1220.

In some embodiments, the semiconductor workpiece inspection system 1000 may be configured to provide electromagnetic radiation 1225 at multiple different incident angles at or around the same spatial location on the semiconductor workpiece 1250. This may allow the imaging device to capture the response (e.g., optical response such as scattering, transmission, absorption, reflection) of the workpiece 1250 and/or anomalies or defects in the workpiece 1250 to the electromagnetic radiation 1225 at different incident angles. This data may be used to provide and/or enhance images of the semiconductor workpiece 1250, such as darkfield images of the semiconductor workpiece 1250.

In some examples, the optical path 1240 may be used to shape the electromagnetic radiation 1225. For instance, the optical path 1240 may be used to shape the beam of coherent ultraviolet radiation. In some embodiments, the optical path 1240 includes one or more optical devices and/or optical elements to shape the electromagnetic radiation 1225 so that it has a uniform projection on a surface of the semiconductor workpiece 1250 to enhance image data capture and/or increase image data area capture. The shaping of the electromagnetic radiation 1225, in some examples, may compensate for providing the electromagnetic radiation 1225 at a non-parallel incident angle θ relative to an axis 1260 normal to a major surface of the semiconductor workpiece 1250. In some examples, the optical path 1240 may shape the beam according to the incident angle such that the intensity of the electromagnetic radiation 1225 is uniform in the area of contact on the surface of the semiconductor workpiece 1250 and/or the area of contact on the semiconductor workpiece 1250 can be modified in relation to the field of view of the imaging device 1220.

In some examples, the optical path 1240 may shape the electromagnetic radiation 1225 such that a projection of the electromagnetic radiation 1225 on a surface of the semiconductor workpiece 1250 is generally uniform. As used herein, a projection is generally uniform when the projection has two spatial dimensions (e.g., length, width) that are within 10% of one another.

In some examples, the optical path 1240 may shape the electromagnetic radiation 1225 such that a projection of the electromagnetic radiation 1225 on a surface of the semiconductor workpiece 1250 is generally circular. As used herein, a projection is “generally circular” when the projection has a perimeter where no point deviates from a true circle by more than 10% of the projection's radius, allowing for minor variations while maintaining an overall circular geometry.

In some examples, the optical path 1240 may shape the electromagnetic radiation 1225 such that a projection of the electromagnetic radiation 1225 on a surface of the semiconductor workpiece 1250 has a longest spatial dimension (e.g., length, diameter) that is within 10% of a longest spatial dimension of a field of view of the imaging device 1220 at the surface of the semiconductor workpiece 1250. In this way, the projection of the electromagnetic radiation 1225 may be tailored to increase and make more uniform the area of data capture of the imaging device, even when providing the electromagnetic radiation 1225 at a non-parallel incident angle θ relative to an axis 1260 normal to a major surface of the semiconductor workpiece 1250.

For instance, in some examples, the optical path may include a light attenuator 1240a. The light attenuator 1240a may be included to help modulate an intensity of the electromagnetic radiation 1225 from the radiation source 1222. This may be valuable, for example, in situations where a laser output of a coherent ultraviolet radiation source is too strong for the semiconductor workpiece 1250 or if precise control over the laser power is needed. Damaging the semiconductor workpiece 1250 due to a laser intensity would be counterproductive to identifying and mitigating defects or other features on or in the semiconductor workpiece 1250. The light attenuator 1240a can absorb and/or scatter a portion of the laser light passing therethrough. This can reduce the beam intensity without significantly altering its properties such as its spatial and temporal characteristics.

The optical path 1240 may include a beam expansion optical element 1240b. The beam expansion optical element may expand a shape of the electromagnetic radiation 1225. For instance, the beam expansion optical element may expand a shape (e.g., spot size) of the electromagnetic radiation at least 5×, such as at least 10×, such as at least 15×, such as in a range of 5× to 15×.

The optical path 1240 may include reflective elements 1240c and 1240d (e.g., mirrors) to direct the electromagnetic radiation 1225 to other optical elements in the optical path 1240 and/or to the semiconductor workpiece 1250. FIG. 8 depicts one example arrangement of reflective elements 1240c, 1240d for purposes of illustration and discussion. Those of ordinary skill in the art, using the disclosures provided herein, will understand that the optical path 1240 may include any number, configuration, arrangement, or no reflective elements without deviating from the scope of the present disclosure.

The optical path 1240 may include a beam shaping optical element 1240e. The beam shaping optical element 1240e may introduce a non-uniformity in a shape of the electromagnetic radiation 1225. For instance, the beam shaping optical element 1240e may stretch and/or compress the electromagnetic radiation 1225 in one or more axes, but not all axes uniformly. For instance, the beam shaping optical element 1240e may provide electromagnetic radiation 1225 with an elliptical shape or projection.

The optical path 1240 may include a reflective optical element 1240f to direct the electromagnetic radiation 1225 to the surface of the semiconductor workpiece 1250, for instance, at an incident angle θ. A controller (not illustrated) can control one or more of the optical elements 1240a, 1240b, 1240c, 1240d, 1240e, 1240f to provide a desired projection of the electromagnetic radiation 1225 on a surface of the semiconductor workpiece 1250 at a desired incident angle θ.

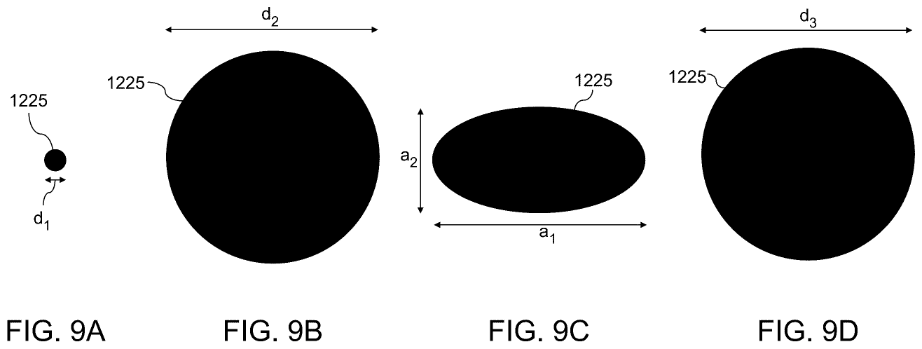

FIGS. 9A, 9B, 9C, and 9D depict a shape of the electromagnetic radiation 1225 (e.g., coherent ultraviolet radiation) at various points in the example optical path 1240 of FIG. 8. For instance, FIG. 9A depicts the shape of the electromagnetic radiation 1225 at point A of FIG. 8. The electromagnetic radiation 1225 at point A may have a diameter d1. FIG. 9B depicts the shape of the electromagnetic radiation 1225 at point B of FIG. 8 after passing through the beam expansion optical element 1240b. As illustrated, the electromagnetic radiation 1225 has a larger diameter d2 relative to d1, such as about 5× or greater, such as 10× or greater, such as 15× or greater. FIG. 9C depicts the shape of the electromagnetic radiation 1225 at point C after passing through the beam shaping optical element 1240e. As shown, the electromagnetic radiation 1225 has an introduced non-uniformity by compressing the electromagnetic radiation 1225 along one dimension such that a spatial dimension along axis a1 is greater than a spatial dimension along axis a2.

FIG. 9D depicts the projection of the electromagnetic radiation 1225 on the surface of the semiconductor workpiece 1250. As shown, the projection of the electromagnetic radiation 1225 is generally uniform. In the example of FIG. 9D, the projection is generally circular with a diameter d3. The diameter d3 may be within 10% of a largest dimension of the field of view of the imaging device 1220 at the surface of the semiconductor workpiece 1250. In this way, the semiconductor workpiece inspection system 1000 may include an optical path 1240 that provides electromagnetic radiation having a first shape (e.g., elliptical shape) at point C (e.g., using beam shaping optical element 1240e) and a second shape at a projection of the electromagnetic radiation 1225 on surface of the semiconductor workpiece 1250. The second shape has increased uniformity relative to the first shape (more spatial dimensions that are about equal to one another).

Referring back to FIG. 8, in some examples, the imaging device 1220 may include a photoluminescence detector configured to detect photoluminescence, such as fluorescence. The photoluminescence detector can include one or more of photomultiplier tubes, avalanche photodiodes, a CCD sensor, and/or a CMOS sensors. The photoluminescence detector may be configured to detect one or more ranges of fluorescence, such as about 400-500 (e.g., blue emissions), about 500-600 nm (e.g., green emissions), about 600-700 nm (e.g., red emissions), about 700-1100 nm (e.g., infrared emissions). Narrower and/or additional bands of photoluminescence may be detected without deviating from the scope of the present disclosure.

As indicated in FIG. 3, the imaging device 1220 may be configured to be movable or translatable along one or more degrees of freedom. For example, the imaging device 1220 may be translatable along a z-axis. Other degrees of freedom, such as x- and/or y-axis translations may be possible. In some embodiments, the imaging device 1220 can be rotated along one or more of the x-, y-, and/or z-axis. The controller may be configured to control these movements.

In some embodiments, the imaging device may include an optical filter 1270. The optical filter 1270 may include a filter wheel including a plurality of optical filters, such as wavelength range filters. The optical filter 1270 may be controllable by the controller. In some embodiments, the optical filter 1270 includes filters for one or more of the ranges of fluorescence (e.g., blue fluorescence, green fluorescence, red fluorescence, infrared fluorescence) described above. FIG. 3 depicts an example where the optical filter 270 may include an optical wheel with a plurality of optical filters which provides the system the ability to customize filter selection and allow an image to be scanned with multiple filters. This is advantageous for the optimization of multiple defect class detection, and/or increased defect detection by combining data from multiple filters for certain defect classes.

In some examples, the semiconductor workpiece inspection system 1000 may include a workpiece holder 1245. The workpiece holder 1245 may be operable to hold a semiconductor workpiece 1250. An example workpiece holder 1245 is illustrated in FIGS. 4-5. In some examples, the workpiece holder 1245 may be movable or translatable in one or more directions (e.g., x, y, and/or z directions).

In some embodiments, non-uniformities that may be present in the capturing of data by the image capture device (e.g., resulting from non-uniform illumination of the workpiece at a non-parallel incident angle θ) can be mitigated through post-capture image processing. In some examples, the post-capture image processing may be software based and may be implemented by one or more processors executing computer-readable instructions stored in one or more memory devices. The post-capture image processing may include one or more image processing algorithms, including, but not limited to, flat-field correction, statistical normalization, and adaptive filtering. By analyzing and characterizing the systematic deviations caused by, for instance, uneven electromagnetic radiation on the workpiece, these techniques can computationally compensate for pixel-level, segment level, and/or line-level intensity inconsistencies, thereby producing a corrected image with enhanced uniformity and a more accurate representation of the workpiece's true characteristics, without requiring physical modifications to the imaging hardware.

Example aspects of the present disclosure are set forth below. Any of the below features or examples may be used in combination with any of the embodiments or features provided in the present disclosure.

In an aspect, the present disclosure provides an example semiconductor workpiece inspection system. The inspection system includes a workpiece holder operable to hold a semiconductor workpiece. The inspection system includes a first channel comprising a first imaging device configured to image the semiconductor workpiece on the workpiece using a first radiation source. The inspection system includes a second channel comprising a second imaging device configured to image the semiconductor workpiece on the workpiece holder using a second radiation source.

In some implementations of the example semiconductor workpiece inspection system, the first channel is configured to be independently adjustable from the second channel.

In some implementations of the example semiconductor workpiece inspection system, the first channel is configured to be at least one of focused, tuned, or scanned without modifying the second channel.

In some implementations of the example semiconductor workpiece inspection system, the first channel includes a photoluminescence imaging device configured to image the semiconductor workpiece by directing ultraviolet light at the semiconductor workpiece.

In some implementations of the example semiconductor workpiece inspection system, the photoluminescence imaging device is configured to detect photoluminescence emitted from the semiconductor workpiece.

In some implementations of the example semiconductor workpiece inspection system, the inspection system further comprises a light attenuator configured to modify an intensity of the ultraviolet light.

In some implementations of the example semiconductor workpiece inspection system, the inspection system further comprises a power meter configured to indicate an intensity of the ultraviolet light.

In some implementations of the example semiconductor workpiece inspection system, the first radiation source includes an ultraviolet radiation source.

In some implementations of the example semiconductor workpiece inspection system, the ultraviolet radiation source includes at least one of a laser, an LED, or an arc lamp.

In some implementations of the example semiconductor workpiece inspection system, the photoluminescence imaging device includes a fluorescence detector configured to detect fluorescence emitted from the semiconductor workpiece.

In some implementations of the example semiconductor workpiece inspection system, the fluorescence detector includes at least one of a SPAD single line detector, an electron-multiplying CCD detector, or a charge domain CMOS TDI sensor.

In some implementations of the example semiconductor workpiece inspection system, the fluorescence detector includes at least one of a photomultiplier tube or a photodiode.

In some implementations of the example semiconductor workpiece inspection system, the fluorescence detector includes a filter wheel comprising a plurality of optical filters.

In some implementations of the example semiconductor workpiece inspection system, the inspection system further comprises a plurality of optical elements configured to at least one of collimate, focus, or reflect the ultraviolet light.

In some implementations of the example semiconductor workpiece inspection system, each of the optical elements is disposed between the ultraviolet radiation source and the fluorescence detector.

In some implementations, the example semiconductor workpiece inspection system includes a confocal chromatic sensor configured to obtain data indicative of a distance to the semiconductor workpiece or a thickness of the semiconductor workpiece.

In some implementations of the example semiconductor workpiece inspection system, the confocal chromatic sensor is configured to be independently operable from the first and second imaging devices.

In some implementations of the example semiconductor workpiece inspection system, the first channel is configured to be adjusted independent of the second channel based on data received from the confocal chromatic sensor.

In some implementations of the example semiconductor workpiece inspection system, the second channel includes a birefringent contrast imaging device configured to image the semiconductor workpiece by directing polarized light at the semiconductor workpiece.

In some implementations of the example semiconductor workpiece inspection system, the birefringent contrast imaging device is configured to detect a light signal transmitted through the semiconductor workpiece.

In some implementations of the example semiconductor workpiece inspection system, the inspection system further comprises an illuminator configured to illuminate a face of the semiconductor workpiece.

In some implementations of the example semiconductor workpiece inspection system, the first radiation source includes a polarized light source configured to emit the polarized light.

In some implementations of the example semiconductor workpiece inspection system, the polarized light source includes a laser configured to generate near-infrared light.

In some implementations of the example semiconductor workpiece inspection system, the laser is configured to generate despeckled light.

In some implementations of the example semiconductor workpiece inspection system, the birefringent contrast imaging device includes an optical detector.

In some implementations of the example semiconductor workpiece inspection system, the optical detector includes at least one of a polarimeter or a polarizing photodetector.

In some implementations of the example semiconductor workpiece inspection system, the optical detector includes at least one of a line-scan camera, a single line camera, or a SPAD detector.

In some implementations of the example semiconductor workpiece inspection system, the optical detector includes an InGaAs line-scan detector configured to detect birefringence in silicon.

In some implementations of the example semiconductor workpiece inspection system, the inspection system further comprises a plurality of optical elements configured to at least one of collimate, focus, or reflect the polarized light.

In some implementations of the example semiconductor workpiece inspection system, each of the optical elements is disposed between the polarized light source and the optical detector.

In some implementations of the example semiconductor workpiece inspection system, at least one of the optical elements includes at least one of a polarizing beamsplitter, a half waveplate, or a Wollaston prism.

In some implementations of the example semiconductor workpiece inspection system, the inspection system further comprises a fiducial structure comprising one or more fiducial markers detectable by the first and second imaging devices.

In some implementations of the example semiconductor workpiece inspection system, the one or more fiducial markers are detectable in a birefringent contrast image modality and a photoluminescence image modality.

In some implementations of the example semiconductor workpiece inspection system, the one or more fiducial markers are disposed along a scanning axis of the semiconductor workpiece.

In some implementations of the example semiconductor workpiece inspection system, the semiconductor workpiece and the one or more fiducial markers comprise a common semiconductor material.

In some implementations of the example semiconductor workpiece inspection system, the one or more fiducial markers comprise at least one of an ArUco pattern, an AprilTag pattern, a CALTag pattern, or an ARTag pattern.

In some implementations of the example semiconductor workpiece inspection system, the one or more fiducial markers are on the workpiece holder.

In some implementations of the example semiconductor workpiece inspection system, the fiducial structure is on the workpiece holder.

In some implementations of the example semiconductor workpiece inspection system, the fiducial structure is on a peripheral side of the workpiece holder.

In some implementations of the example semiconductor workpiece inspection system, the inspection system further comprises control circuitry configured to: receive first image data associated with the first imaging device; receive second image data associated with the second imaging device; identify fiducial marker data within each of the first and second image data; and spatially correlate, based on the fiducial marker data, the first and second image data.

In some implementations of the example semiconductor workpiece inspection system, the control circuitry is configured to: receive the first and second image data simultaneously.

In some implementations of the example semiconductor workpiece inspection system, the control circuitry is configured to: receive the first and second image data sequentially.

In some implementations of the example semiconductor workpiece inspection system, spatially correlating the first and second image data comprises: setting a first viewpoint of the first imaging device at a first portion of the semiconductor workpiece; and setting a second viewpoint of the second imaging device at a second portion of the semiconductor workpiece.

In some implementations of the example semiconductor workpiece inspection system, spatially correlating the first and second image data further comprises: focusing the first imaging device at the first portion of the semiconductor workpiece; and focusing the second imaging device at the second portion of the semiconductor workpiece.

In some implementations of the example semiconductor workpiece inspection system, the control circuitry is configured to: generate, based on the fiducial marker data, a map of the semiconductor workpiece along three orthogonal axes.

In some implementations of the example semiconductor workpiece inspection system, generating the map of the semiconductor workpiece along three orthogonal axes further comprises: mapping, based on the fiducial marker data, the semiconductor workpiece along the three orthogonal axes.

In some implementations of the example semiconductor workpiece inspection system, the control circuitry is configured to: store the map; and access the stored map.

In some implementations of the example semiconductor workpiece inspection system, the control circuitry is configured to: spatially correlate, based on the stored map, at least one of the first or second imaging devices with pixel-level accuracy.

In some implementations of the example semiconductor workpiece inspection system, the inspection system further comprises a third channel comprising a third imaging device configured to image the semiconductor workpiece using a third radiation source.

In some implementations of the example semiconductor workpiece inspection system, the third imaging device is configured to generate a darkfield image.

In some implementations of the example semiconductor workpiece inspection system, the third imaging device includes one or more fused silica lenses.

In some implementations of the example semiconductor workpiece inspection system, the third imaging device is configured to generate a brightfield image using reflected light.

In some implementations of the example semiconductor workpiece inspection system, the control circuitry is configured further to: determine one or more workpiece characteristics of the semiconductor workpiece based at least in part on the map of the semiconductor workpiece.

In some implementations of the example semiconductor workpiece inspection system, the one or more workpiece characteristics comprise at least one of: one or more defects associated with the semiconductor workpiece; a surface roughness of the semiconductor workpiece; a parallelism of the semiconductor workpiece; or an optical wedge of the semiconductor workpiece.

In some implementations of the example semiconductor workpiece inspection system, the control circuitry is further configured to generate feedback data indicative of one or more defects associated with a fabrication process of the semiconductor workpiece.

In some implementations of the example semiconductor workpiece inspection system, wherein the feedback data is indicative of one or more defects in at least one of: a grinding process associated with the semiconductor workpiece; a lapping process associated with the semiconductor workpiece; a polishing process associated with the semiconductor workpiece; or a crystal growth process associated with the semiconductor workpiece.

In an aspect, the present disclosure provides an example semiconductor workpiece inspection system. The inspection system includes a photoluminescence imaging device configured to image a semiconductor workpiece by directing ultraviolet light at the semiconductor workpiece and detecting photoluminescence emitted from the semiconductor workpiece. The inspection system includes a birefringent contrast imaging device configured to image the semiconductor workpiece by directing polarized light at the semiconductor workpiece and detecting a light signal transmitted through the semiconductor workpiece.

In some examples of the example semiconductor workpiece inspection system, the inspection system further comprises a light attenuator configured to modify an intensity of the ultraviolet light.

In some examples of the example semiconductor workpiece inspection system, the inspection system further comprises a power meter configured to indicate an intensity of the ultraviolet light.

In some implementations of the example semiconductor workpiece inspection system, the photoluminescence imaging device includes an ultraviolet radiation source.

In some implementations of the example semiconductor workpiece inspection system, the ultraviolet radiation source includes at least one of a laser, an LED, or an arc lamp.

In some implementations of the example semiconductor workpiece inspection system, the photoluminescence imaging device includes a fluorescence detector configured to detect fluorescence emitted from the semiconductor workpiece.

In some implementations of the example semiconductor workpiece inspection system, the fluorescence detector includes at least one of a SPAD single line detector, an electron-multiplying CCD detector, or a charge domain CMOS TDI sensor.

In some implementations of the example semiconductor workpiece inspection system, the fluorescence detector includes at least one of a photomultiplier tube or a photodiode.

In some implementations of the example semiconductor workpiece inspection system, the fluorescence detector includes a filter wheel comprising a plurality of optical filters.

In some examples of the example semiconductor workpiece inspection system, the inspection system further comprises a plurality of optical elements configured to at least one of collimate, focus, or reflect the ultraviolet light.

In some implementations of the example semiconductor workpiece inspection system, each of the optical elements is disposed between the ultraviolet radiation source and the fluorescence detector.

In some implementations, the example semiconductor workpiece inspection system includes a confocal chromatic sensor configured to obtain data indicative of a distance to the semiconductor workpiece or a thickness of the semiconductor workpiece.

In some examples of the example semiconductor workpiece inspection system, the inspection system further comprises an illuminator configured to illuminate a face of the semiconductor workpiece.

In some implementations of the example semiconductor workpiece inspection system, the birefringent contrast imaging device includes a polarized light source configured to emit the polarized light.

In some implementations of the example semiconductor workpiece inspection system, the polarized light source includes a laser configured to generate near-infrared light.

In some implementations of the example semiconductor workpiece inspection system, the laser is configured to generate despeckled light.

In some implementations of the example semiconductor workpiece inspection system, the birefringent contrast imaging device includes an optical detector.

In some implementations of the example semiconductor workpiece inspection system, the optical detector includes at least one of a polarimeter or a polarizing photodetector.

In some implementations of the example semiconductor workpiece inspection system, the optical detector includes at least one of a line-scan camera, a single line camera, or a SPAD detector.

In some implementations of the example semiconductor workpiece inspection system, the optical detector includes an InGaAs line-scan detector configured to detect birefringence in silicon.

In some examples of the example semiconductor workpiece inspection system, the inspection system further comprises a plurality of optical elements configured to at least one of collimate, focus, or reflect the polarized light.

In some implementations of the example semiconductor workpiece inspection system, each of the optical elements is disposed between the polarized light source and the optical detector.

In some implementations of the example semiconductor workpiece inspection system, at least one of the optical elements includes at least one of a polarizing beamsplitter, a half waveplate, or a Wollaston prism.

In some examples of the example semiconductor workpiece inspection system, the inspection system further comprises one or more fiducial markers detectable by the birefringent contrast imaging device and the photoluminescence image device.

In some implementations of the example semiconductor workpiece inspection system, the one or more fiducial markers are disposed along a scanning axis of the semiconductor workpiece.

In some implementations of the example semiconductor workpiece inspection system, the semiconductor workpiece and the one or more fiducial markers comprise a common semiconductor material.

In some examples of the example semiconductor workpiece inspection system, the inspection system further comprises a workpiece holder configured to support the semiconductor workpiece.

In some implementations of the example semiconductor workpiece inspection system, the one or more fiducial markers are on the workpiece holder.

In some implementations of the example semiconductor workpiece inspection system, the one or more fiducial markers are on a peripheral side of the workpiece holder.

In some examples of the example semiconductor workpiece inspection system, the inspection system further comprises control circuitry configured to: receive first image data associated with the photoluminescence imaging device; receive second image data associated with the birefringent contrast imaging device; identify fiducial marker data within each of the first and second image data; and spatially correlate, based on the fiducial marker data, the first and second image data.

In some examples of the example semiconductor workpiece inspection system, the control circuitry is configured further to: receive the first and second image data simultaneously.

In some examples of the example semiconductor workpiece inspection system, the control circuitry is configured further to: receive the first and second image data sequentially.

In some examples of the example semiconductor workpiece inspection system, spatially correlating the first and second image data comprises: setting a first viewpoint of the photoluminescence imaging device at a first portion of the semiconductor workpiece; and setting a second viewpoint of the birefringent contrast imaging device at a second portion of the semiconductor workpiece.

In some examples of the example semiconductor workpiece inspection system, spatially correlating the first and second image data further comprises: mapping, based on the fiducial marker data, the semiconductor workpiece along three orthogonal axes.

In some examples of the example semiconductor workpiece inspection system, spatially correlating the first and second image data further comprises: focusing the photoluminescence imaging device at the first portion of the semiconductor workpiece; and focusing the birefringent contrast imaging device at the second portion of the semiconductor workpiece.

In some examples of the example semiconductor workpiece inspection system, the control circuitry is configured further to: generate, based on the fiducial marker data, a map of the semiconductor workpiece along three orthogonal axes.

In some examples of the example semiconductor workpiece inspection system, the control circuitry is configured further to: store the map; and access the stored map.

In some examples of the example semiconductor workpiece inspection system, the control circuitry is configured further to: spatially correlate, based on the stored map, at least one of the photoluminescence imaging device or the photoluminescence imaging device with pixel-level accuracy.

In some examples of the example semiconductor workpiece inspection system, the system further comprises a third imaging device configured to image the semiconductor workpiece using a third technique.

In some implementations of the example semiconductor workpiece inspection system, the third imaging device is configured to generate a darkfield image.

In some implementations of the example semiconductor workpiece inspection system, the third imaging device includes one or more fused silica lenses.

In some implementations of the example semiconductor workpiece inspection system, the third imaging device is configured to generate a brightfield image using reflected light.

In an aspect, the present disclosure provides an example controller usable in a semiconductor workpiece inspection system. The controller includes one or more computer readable storage devices configured to store computer-executable instructions; and one or more hardware computer processors in communication with the one or more computer readable storage devices and configured to execute computer-readable instructions to cause the controller to: workpiece on a workpiece holder; cause a first imaging device to capture first image data of a semiconductor workpiece on a workpiece holder; cause a second imaging device to capture second image data of the semiconductor workpiece on the workpiece holder; and adjust one or more imaging parameters of the first imaging device independently of the second imaging device.

In some implementations of the example controller, the first imaging device comprises a photoluminescence imaging device and wherein the one or more hardware computer processors are configured to execute the computer-executable instructions to cause the controller further to: image the semiconductor workpiece using ultraviolet light directed at the semiconductor workpiece.

In some implementations of the example controller, the first imaging device comprises a photoluminescence imaging device and wherein the one or more hardware computer processors are configured to execute the computer-executable instructions to cause the controller further to: detect, using the photoluminescence imaging device, photoluminescence emitted from the semiconductor workpiece.

In some implementations of the example controller, the one or more hardware computer processors are configured to execute the computer-executable instructions to cause the controller further to: modify, using a light attenuator, an intensity of the ultraviolet light.

In some implementations of the example controller, the one or more hardware computer processors are configured to execute the computer-executable instructions to cause the controller further to: indicate, using a power meter, an intensity of the ultraviolet light.

In some implementations of the example controller, the photoluminescence imaging device comprises a fluorescence detector, and wherein the one or more hardware computer processors are configured to execute the computer-executable instructions to cause the controller further to: detect, using the fluorescence detector, fluorescence emitted from the semiconductor workpiece.

In some implementations of the example controller, the fluorescence detector comprises a filter wheel having a plurality of optical filters, and wherein the one or more hardware computer processors are configured to execute the computer-executable instructions to cause the controller further to: filter the emitted fluorescence using the filter wheel.

In some implementations of the example controller, the one or more hardware computer processors are configured to execute the computer-executable instructions to cause the controller further to: obtain, using a confocal chromatic sensor, data indicative of a distance to the semiconductor workpiece or a thickness of the semiconductor workpiece.

In some implementations of the example controller, the second imaging device comprises a birefringent contrast imaging device, and wherein the one or more hardware computer processors are configured to execute the computer-executable instructions to cause the controller further to: image, using the birefringent contrast imaging device, the semiconductor workpiece using polarized light directed at the semiconductor workpiece.

In some implementations of the example controller, the one or more hardware computer processors are configured to execute the computer-executable instructions to cause the controller further to: detect, using the birefringent contrast imaging device, a light signal transmitted through the semiconductor workpiece.

In some implementations of the example controller, the one or more hardware computer processors are configured to execute the computer-executable instructions to cause the controller further to: illuminate, using an illuminator, a face of the semiconductor workpiece.

In some implementations of the example controller, the first imaging device includes a coherent radiation source configured to emit coherent polarized light.

In some implementations of the example controller, the one or more hardware

computer processors are configured to execute the computer-executable instructions to cause the controller further to: cause the coherent radiation source to generate despeckled light.

In some implementations of the example controller, the one or more hardware computer processors are configured to execute the computer-executable instructions to cause the controller further to: receive the first and second image data simultaneously.

In some implementations of the example controller, the one or more hardware computer processors are configured to execute the computer-executable instructions to cause the controller further to: receive the first and second image data sequentially.

In some implementations of the example controller, the one or more hardware computer processors are configured to execute the computer-executable instructions to cause the controller further to: identify fiducial marker data within each of the first and second image data.

In some implementations of the example controller, the one or more hardware computer processors are configured to execute the computer-executable instructions to cause the controller further to: spatially correlate, based on the fiducial marker data, the first and second image data.

In some implementations of the example controller, spatially correlating the first and second image data comprises: setting a first viewpoint of the first imaging device at a first portion of the semiconductor workpiece; and setting a second viewpoint of the second imaging device at a second portion of the semiconductor workpiece.

In some implementations of the example controller, spatially correlating the first and second image data further comprises: mapping, based on the fiducial marker data, the semiconductor workpiece along three orthogonal axes.

In some implementations of the example controller, spatially correlating the first and second image data further comprises: focusing the first imaging device at the first portion of the semiconductor workpiece; and focusing the second imaging device at the second portion of the semiconductor workpiece.

In some implementations of the example controller, the one or more hardware computer processors are configured to execute the computer-executable instructions to cause the controller further to: generate, based on the fiducial marker data, a map of the semiconductor workpiece along three orthogonal axes.

In some implementations of the example controller, wherein the one or more hardware computer processors are configured to execute the computer-executable instructions to cause the controller further to: store the map; and access the stored map.

In some implementations of the example controller, the one or more hardware computer processors are configured to execute the computer-executable instructions to cause the controller further to: spatially correlate, based on the stored map, at least one of the first or second imaging devices with pixel-level accuracy.

In some implementations of the example controller, the one or more hardware computer processors are configured to execute the computer-executable instructions to cause the controller further to: image, using a third imaging device having a third radiation source, the semiconductor workpiece.

In some implementations of the example controller, the one or more hardware computer processors are configured to execute the computer-executable instructions to cause the controller further to: generate, using the third imaging device, a darkfield image.

In some implementations of the example controller, the one or more hardware computer processors are configured to execute the computer-executable instructions to cause the controller further to: generate, using the third imaging device, a brightfield image using reflected light.

In some implementations of the example controller, the imaging parameters comprise at least one of a focal length, a scanning speed, a type of light, or a light intensity of the light.

In some implementations of the example controller, the one or more hardware computer processors are configured to execute the computer-executable instructions to cause the controller further to: determine one or more workpiece characteristics of the semiconductor workpiece based at least in part on the spatially correlated first and second image data.

In some implementations of the example controller, the one or more workpiece characteristics comprise at least one of: one or more defects associated with the semiconductor workpiece; a surface roughness of the semiconductor workpiece; a parallelism of the semiconductor workpiece; or an optical wedge of the semiconductor workpiece.

In some implementations of the example controller, the one or more processors are further configured to generate feedback data indicative of one or more defects associated with a fabrication process of the semiconductor workpiece.

In some implementations of the example controller, the feedback data is indicative of one or more defects in at least one of: a grinding process associated with the semiconductor workpiece; a lapping process associated with the semiconductor workpiece; a polishing process associated with the semiconductor workpiece; or a crystal growth process associated with the semiconductor workpiece.

In some implementations of the example controller, the one or more hardware computer processors are configured to execute the computer-executable instructions to cause the controller further to: modify a fabrication process associated with the semiconductor workpiece based at least in part on the spatially correlated first and second image data.

In some implementations of the example controller, the one or more hardware computer processors are configured to execute the computer-executable instructions to cause the controller further to: generate feedback data associated with the fabrication process based at least in part on the spatially correlated first and second image data, the feedback data being indicative of one or more defects associated with the fabrication process; and modify the fabrication process associated with the semiconductor workpiece based at least in part on the feedback data.

In some implementations of the example controller, modifying the fabrication process associated with the semiconductor workpiece includes identifying the semiconductor workpiece for a different fabrication operation to address the one or more defects associated with the feedback data.

In some implementations of the example controller, modifying the fabrication process associated with the semiconductor workpiece includes modifying a surface processing process associated with the semiconductor workpiece, the surface processing process comprising one or more of a grinding process, a lapping process, or a polishing process.

In some implementations of the example controller, modifying the fabrication process associated with the semiconductor workpiece includes determining whether to discard the semiconductor workpiece.

In some implementations of the example controller, modifying the fabrication process associated with the semiconductor workpiece includes modifying a crystal growth process associated with the semiconductor workpiece.

In some implementations of the example controller, modifying the fabrication process associated with the semiconductor workpiece includes modifying a prior fabrication operation to reduce future anomalies.

In an aspect, the present disclosure provides an example method. The method includes receiving, using a first imaging device, first image data of a semiconductor workpiece on a semiconductor holder. The method includes receiving, using a second imaging device, second image data of the semiconductor workpiece on the semiconductor holder. The method includes adjusting one or more imaging parameters of the first imaging device independently of the second imaging device.

In some implementations of the example method, the first imaging device comprises a photoluminescence imaging device, the method further comprising: imaging the semiconductor workpiece using ultraviolet light directed at the semiconductor workpiece.

In some implementations of the example method, the first imaging device comprises a photoluminescence imaging device, the method further comprising: detecting, using the photoluminescence imaging device, photoluminescence emitted from the semiconductor workpiece.

In some implementations of the example method, the method further comprises: modifying, using a light attenuator, an intensity of the ultraviolet light.

In some implementations of the example method, the method further comprises: indicating, using a power meter, an intensity of the ultraviolet light.

In some implementations of the example method, the photoluminescence imaging device comprises a fluorescence detector, the method further comprising: detecting, using the fluorescence detector, fluorescence emitted from the semiconductor workpiece.

In some implementations of the example method, the fluorescence detector comprises a filter wheel having a plurality of optical filters, the method further comprising: filtering the emitted fluorescence using the filter wheel.

In some implementations of the example method, the method further comprises: obtaining, using a confocal chromatic sensor, data indicative of a distance to the semiconductor workpiece or a thickness of the semiconductor workpiece.

In some implementations of the example method, wherein the second imaging device comprises a birefringent contrast imaging device, the method further comprising: imaging, using the birefringent contrast imaging device, the semiconductor workpiece using polarized light directed at the semiconductor workpiece.

In some implementations of the example method, the method further comprises: detecting, using the birefringent contrast imaging device, a light signal transmitted through the semiconductor workpiece.

In some implementations of the example method, the method further comprises: illuminating, using an illuminator, a face of the semiconductor workpiece.

In some implementations of the example method, the first imaging device comprises a coherent radiation source configured to emit coherent polarized light, the method further comprising: causing the coherent radiation source to generate despeckled light.

In some implementations of the example method, the method further comprises: receiving the first and second image data simultaneously.

In some implementations of the example method, the method further comprises: receiving the first and second image data sequentially.

In some implementations of the example method, the method further comprises: identifying fiducial marker data within each of the first and second image data.

In some implementations of the example method, the method further comprises: spatially correlating, based on the fiducial marker data, the first and second image data.

In some implementations of the example method, spatially correlating the first and second image data comprises: setting a first viewpoint of the first imaging device at a first portion of the semiconductor workpiece; and setting a second viewpoint of the second imaging device at a second portion of the semiconductor workpiece.

In some implementations of the example method, spatially correlating the first and second image data further comprises: mapping, based on the fiducial marker data, the semiconductor workpiece along three orthogonal axes.

In some implementations of the example method, spatially correlating the first and second image data further comprises: focusing the first imaging device at a first portion of the semiconductor workpiece; and focusing the second imaging device at a second portion of the semiconductor workpiece.

In some implementations of the example method, the method further comprises generating, based on the fiducial marker data, a map of the semiconductor workpiece along three orthogonal axes.

In some implementations of the example method, the method further comprises: storing the map; and accessing the stored map.

In some implementations of the example method, the method further comprises: spatially correlating, based on the stored map, at least one of the first or second imaging devices with pixel-level accuracy.

In some implementations of the example method, the method further comprises: imaging, using a third imaging device having a third radiation source, the semiconductor workpiece.

In some implementations of the example method, the method further comprises: generating, using the third imaging device, a darkfield image.

In some implementations of the example method, the method further comprises: generating, using the third imaging device, a brightfield image using reflected light.

In some implementations of the example method, the imaging parameters comprise at least one of a focal length, a scanning speed, a type of light, or a light intensity of the light.

In some implementations of the example method, the method further comprises: determining one or more workpiece characteristics of the semiconductor workpiece based at least in part on the spatially correlated first and second image data.

In some implementations of the example method, the one or more workpiece characteristics comprise at least one of: one or more defects associated with the semiconductor workpiece; a surface roughness of the semiconductor workpiece; a parallelism of the semiconductor workpiece; or an optical wedge of the semiconductor workpiece.

In some implementations of the example method, the method further comprises generating feedback data indicative of one or more defects associated with a fabrication process of the semiconductor workpiece.

In some implementations of the example method, the feedback data is indicative of one or more defects in at least one of: a grinding process associated with the semiconductor workpiece; a lapping process associated with the semiconductor workpiece; a polishing process associated with the semiconductor workpiece; or a crystal growth process associated with the semiconductor workpiece.

In some implementations of the example method, the method further comprises: modifying a fabrication process associated with the semiconductor workpiece based at least in part on the spatially correlated first and second image data.

In some implementations of the example method, the method further comprises: generating feedback data associated with the fabrication process based at least in part on the spatially correlated first and second image data, the feedback data being indicative of one or more defects associated with the fabrication process; and modifying the fabrication process associated with the semiconductor workpiece based at least in part on the feedback data.

In some implementations of the example method, modifying the fabrication process associated with the semiconductor workpiece includes identifying the semiconductor workpiece for a different fabrication operation to address the one or more defects associated with the feedback data.

In some implementations of the example method, modifying the fabrication process associated with the semiconductor workpiece includes modifying a surface processing process associated with the semiconductor workpiece, the surface processing process comprising one or more of a grinding process, a lapping process, or a polishing process.

In some implementations of the example method, modifying the fabrication process associated with the semiconductor workpiece includes determining whether to discard the semiconductor workpiece.

In some implementations of the example method, modifying the fabrication process associated with the semiconductor workpiece includes modifying a crystal growth process associated with the semiconductor workpiece.

In some implementations of the example method, modifying the fabrication process associated with the semiconductor workpiece includes modifying a prior fabrication operation to reduce future anomalies.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion of the semiconductor workpiece. In some implementations, the radiation source is configured to provide the electromagnetic radiation such that the electromagnetic radiation is incident on a surface of the semiconductor workpiece at an incident angle relative to an axis normal to a major surface of the semiconductor workpiece that is in a range of about 45° to about 85°.

In some implementations of the example semiconductor workpiece inspection system, the incident angle is within about 10° of the Brewster angle for the semiconductor workpiece.

In some implementations of the example semiconductor workpiece inspection system, the radiation source includes an ultraviolet radiation source.

In some implementations of the example semiconductor workpiece inspection system, the radiation source includes an ultraviolet laser source configured to provide coherent ultraviolet radiation to the semiconductor workpiece.

In some implementations of the example semiconductor workpiece inspection system, the imaging device includes a line scan detector or a time delay integration sensor.

In some implementations of the example semiconductor workpiece inspection system, the imaging device is configured to capture light associated with a photoluminescent response of the semiconductor workpiece to the electromagnetic radiation from the radiation source.

In some implementations of the example semiconductor workpiece inspection system, the imaging device is configured to capture a darkfield image of the semiconductor workpiece.

In some implementations of the example semiconductor workpiece inspection system, a projection of the electromagnetic radiation on a surface of the workpiece is generally uniform.

In some implementations of the example semiconductor workpiece inspection system, a projection of the electromagnetic radiation on a surface of the workpiece is generally circular.

In some implementations of the example semiconductor workpiece inspection system, at least one spatial dimension of the projection is within 20% of a largest spatial dimension of a field of view associated with the imaging device at the surface of the semiconductor workpiece.

In some implementations of the example semiconductor workpiece inspection system, the radiation source provides the electromagnetic radiation through an optical path, the optical path including a beam expansion optical element and a beam shaping optical element.

In some implementations of the example semiconductor workpiece inspection system, the beam expansion optical element expands a shape of the electromagnetic radiation.

In some implementations of the example semiconductor workpiece inspection system, the beam shaping optical element introduces a non-uniformity in a shape of the electromagnetic radiation.

In some implementations of the example semiconductor workpiece inspection system, the system further includes a workpiece holder translatable in one or more directions.

In some implementations of the example semiconductor workpiece inspection system, the semiconductor workpiece includes silicon carbide.

In some implementations of the example semiconductor workpiece inspection system, the system further includes one or more processors configured to implement post-capture image processing on the image to at least partially compensate for a non-uniformity in the image associated with providing the electromagnetic radiation incident on the surface of the semiconductor workpiece at the incident angle.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion of the semiconductor workpiece. In some implementations, the radiation source is configured to provide the electromagnetic radiation such that a projection of the electromagnetic radiation on a surface of the semiconductor workpiece is generally uniform.

In some implementations of the example semiconductor workpiece inspection system, the projection of the electromagnetic radiation on the surface of the semiconductor workpiece is generally circular.

In some implementations of the example semiconductor workpiece inspection system, a diameter of the projection is within 10% of a longest dimension of a field of view associated with the imaging device.

In some implementations of the example semiconductor workpiece inspection system, the optical path includes a beam shaping optical element.

In some implementations of the example semiconductor workpiece inspection system, the beam shaping optical element provides a non-uniformity in a shape of the electromagnetic radiation.

In some implementations of the example semiconductor workpiece inspection system, the radiation source includes an ultraviolet radiation source.

In some implementations of the example semiconductor workpiece inspection system, the workpiece imaging system is configured to provide at an incident angle relative to an axis normal to a major surface of the semiconductor workpiece that is in a range of about 45° to about 85°.

In some implementations of the example semiconductor workpiece inspection system, the imaging device includes a line scan detector or a time delay integration sensor.

In some implementations of the example semiconductor workpiece inspection system, the imaging device is configured to capture light associated with a photoluminescent response of the semiconductor workpiece to the electromagnetic radiation from the radiation source.

In some implementations of the example semiconductor workpiece inspection system, the imaging device is configured to capture a darkfield image of the semiconductor workpiece.

In some implementations of the example semiconductor workpiece inspection system, the system further includes a workpiece holder translatable in one or more directions.

In some implementations of the example semiconductor workpiece inspection system, the semiconductor workpiece includes silicon carbide.

In an aspect, the present disclosure provides an example semiconductor workpiece inspection system. In some implementations, the example semiconductor workpiece inspection system includes an ultraviolet laser source configured to direct ultraviolet coherent radiation to a silicon carbide semiconductor workpiece. In some implementations, the example semiconductor workpiece inspection system includes an imaging device configured to capture data associated with a photoluminescent response of at least a portion of the silicon carbide semiconductor workpiece. In some implementations, the ultraviolet laser source is configured to direct the ultraviolet coherent radiation such that the ultraviolet coherent radiation is incident on a surface of the silicon semiconductor workpiece at an incident angle that is within about 10 degrees of a Brewster angle for the semiconductor workpiece.

In some implementations of the example semiconductor workpiece inspection system, the ultraviolet laser source is configured to provide the ultraviolet coherent radiation through an optical path such that a projection of the ultraviolet coherent radiation on a surface of the silicon carbide workpiece is generally circular.

In some implementations of the example semiconductor workpiece inspections system, a diameter of the projection is within 10% of a longest dimension of a field of view associated with the imaging device.

In some implementations of the example semiconductor workpiece inspection system, the optical path including a beam expansion optical element and a beam shaping optical element.

In some implementations of the example semiconductor workpiece inspection system, the beam expansion optical element expands a shape of the ultraviolet coherent radiation.

In some implementations of the example semiconductor workpiece inspection system, the beam shaping optical element provides a non-uniformity in a shape of the ultraviolet coherent radiation.

In some implementations of the example semiconductor workpiece inspection system, the imaging device includes a line scan detector.

In some implementations of the example semiconductor workpiece inspection system, the imaging device includes a time delay integration sensor.

In some implementations of the example semiconductor workpiece inspection system, the system further includes a workpiece holder.

In some implementations of the example semiconductor workpiece inspection system, the workpiece holder is translatable in one or more directions.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion semiconductor workpiece. In some implementations, the radiation source is configured to provide the electromagnetic radiation via an optical path such that the electromagnetic radiation has a first shape in the optical path and a second shape at a projection of the electromagnetic radiation on surface of the semiconductor workpiece. In some implementations, the second shape has increased uniformity relative to the first shape.

In some implementations of the example semiconductor workpiece inspection system, the projection of the electromagnetic radiation on the surface of the semiconductor workpiece is generally circular.

In some implementations of the example semiconductor workpiece inspection system, the first shape is an elliptical shape.

In some implementations of the example semiconductor workpiece inspection system, the optical path includes a beam shaping optical element.

In some implementations of the example semiconductor workpiece inspection system, the beam shaping optical element provides the first shape.

In some implementations of the example semiconductor workpiece inspection system, the radiation source includes an ultraviolet radiation source.

In some implementations of the example semiconductor workpiece inspection system, the workpiece imaging system is configured to provide at an incident angle relative to an axis normal to a major surface of the semiconductor workpiece that is in a range of about 45° to about 85°.

In some implementations of the example semiconductor workpiece inspection system, the imaging device includes a line scan detector or a time delay integration sensor.

In some implementations of the example semiconductor workpiece inspection system, the imaging device is configured to capture light associated with a photoluminescent response of the semiconductor workpiece to the electromagnetic radiation from the radiation source.

In some implementations of the example semiconductor workpiece inspection system, the imaging device is configured to capture a darkfield image of the semiconductor workpiece.

In some implementations of the example semiconductor workpiece inspection system, the system further includes a workpiece holder translatable in one or more directions.

In some implementations of the example semiconductor workpiece inspection system, the semiconductor workpiece includes silicon carbide.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion of the semiconductor workpiece. In some implementations, the radiation source is configured to provide the electromagnetic radiation such that the electromagnetic radiation is incident on a surface of the semiconductor workpiece at an incident angle to increase a photoluminescent response from the semiconductor workpiece to the electromagnetic radiation from the radiation source relative to an incident angle parallel to an axis normal to the surface of the workpiece.

In an aspect, the present disclosure provides an example semiconductor workpiece inspection system. In some implementations, the example semiconductor workpiece inspection system includes a radiation source configured to provide electromagnetic radiation to a semiconductor workpiece. In some implementations, the example semiconductor workpiece inspection system includes an imaging device configured to capture an image of at least a portion of the semiconductor workpiece. In some implementations, the radiation source is configured to provide the electromagnetic radiation such that the electromagnetic radiation is incident on a surface of the semiconductor workpiece at a non-parallel incident angle relative to an axis normal to the surface of the semiconductor workpiece. In some implementations, the semiconductor workpiece imaging system is configured to provide a projection of the electromagnetic radiation on the surface of the semiconductor workpiece to increase uniformity of the projection to compensate for the non-parallel incident angle.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A semiconductor workpiece inspection system, comprising:
a radiation source configured to provide electromagnetic radiation to a semiconductor workpiece;
an imaging device configured to capture an image of at least a portion of the semiconductor workpiece;
wherein the radiation source is configured to provide the electromagnetic radiation such that the electromagnetic radiation is incident on a surface of the semiconductor workpiece at an incident angle relative to an axis normal to a major surface of the semiconductor workpiece that is in a range of about 45° to about 85°.

2. The semiconductor workpiece inspection system of claim 1, wherein the incident angle is within about 10° of the Brewster angle for the semiconductor workpiece.

3. The semiconductor workpiece inspection system of claim 1, wherein the radiation source comprises an ultraviolet radiation source.

4. The semiconductor workpiece inspection system of claim 2, wherein the radiation source comprises an ultraviolet laser source configured to provide coherent ultraviolet radiation to the semiconductor workpiece.

5. The semiconductor workpiece inspection system of claim 1, wherein the imaging device comprises a line scan detector or a time delay integration sensor.

6. The semiconductor workpiece inspection system of claim 1, wherein the imaging device is configured to capture light associated with a photoluminescent response of the semiconductor workpiece to the electromagnetic radiation from the radiation source.

7. The semiconductor workpiece inspection system of claim 1, wherein the imaging device is configured to capture a darkfield image of the semiconductor workpiece.

8. The semiconductor workpiece inspection system of claim 1, wherein a projection of the electromagnetic radiation on a surface of the workpiece is generally uniform.

9. The semiconductor workpiece inspection system of claim 1, wherein a projection of the electromagnetic radiation on a surface of the workpiece is generally circular.

10. The semiconductor workpiece inspection system of claim 9, wherein at least one spatial dimension of the projection is within 20% of a largest spatial dimension of a field of view associated with the imaging device at the surface of the semiconductor workpiece.

11. The semiconductor workpiece inspection system of claim 1, wherein the radiation source provides the electromagnetic radiation through an optical path, the optical path comprising a beam expansion optical element and a beam shaping optical element.

12. The semiconductor workpiece inspection system of claim 11, wherein the beam expansion optical element expands a shape of the electromagnetic radiation.

13. The semiconductor workpiece inspection system of claim 11, wherein the beam shaping optical element introduces a non-uniformity in a shape of the electromagnetic radiation.

14. The semiconductor workpiece inspection system of claim 1, wherein the system further comprises a workpiece holder translatable in one or more directions.

15. The semiconductor workpiece inspection system of claim 1, wherein the semiconductor workpiece comprises silicon carbide.

16. The semiconductor workpiece inspection system of claim 1, wherein the system further comprises one or more processors configured to implement post-capture image processing on the image to at least partially compensate for a non-uniformity in the image associated with providing the electromagnetic radiation incident on the surface of the semiconductor workpiece at the incident angle.

17. A semiconductor workpiece inspection system, comprising:
a radiation source configured to provide electromagnetic radiation to a semiconductor workpiece;
an imaging device configured to capture an image of at least a portion of the semiconductor workpiece;
wherein the radiation source is configured to provide the electromagnetic radiation such that a projection of the electromagnetic radiation on a surface of the semiconductor workpiece is generally uniform.

18. The semiconductor workpiece inspection system of claim 17, wherein the projection of the electromagnetic radiation on the surface of the semiconductor workpiece is generally circular.

19. The semiconductor workpiece inspection system of claim 17, wherein a diameter of the projection is within 10% of a longest dimension of a field of view associated with the imaging device.

20. A semiconductor workpiece inspection system, comprising:
a radiation source configured to provide electromagnetic radiation to a semiconductor workpiece;
an imaging device configured to capture an image of at least a portion of the semiconductor workpiece;
wherein the radiation source is configured to provide the electromagnetic radiation such that the electromagnetic radiation is incident on a surface of the semiconductor workpiece at an incident angle to increase a photoluminescent response from the semiconductor workpiece to the electromagnetic radiation from the radiation source relative to an incident angle parallel to an axis normal to the surface of the workpiece.
